(19) United States
(12) Patent Application Publication
(10) Pub. No.: US 2020/0371513 A1
(43) Pub. Date: Nov. 26, 2020

(54) Maintenance Process Flow Generation Device and Maintenance Process Flow Generation Method

(71) Applicant: Hitachi, Ltd., Tokyo (JP)

(72) Inventors: Toshihiro MORISAWA, Tokyo (JP); Yoshinari HORI, Tokyo (JP); Yasuharu NAMBA, Tokyo (JP); Toshiyuki UKAI, Tokyo (JP)

(21) Appl. No.: 16/825,050

(22) Filed: Mar. 20, 2020

(30) Foreign Application Priority Data
May 20, 2019 (JP) 2019-094868

(51) Int. Cl. G05B 23/02; G05B 19/418

(52) U.S. Cl. CPC G05B 23/0283; G05B 19/4183; G05B 19/41865

(57) ABSTRACT

A maintenance process flow for a plant is automatically generated based on a prediction result of a life of a pipe. A maintenance process flow generation device configured to generate a maintenance process flow for a plant including a plurality of pipes and a plurality of machines as elements, specifies a target pipe, extracts a maintenance range that is a combination of the elements as maintenance targets, determines necessity of a process required for maintenance on the plurality of elements that can be collectively maintained, generates a process flow defining an order relationship of processes executed in the maintenance of the target plant based on a result of the process necessity determination and master process flow information, evaluates workability of the process included in the process flow, calculates work time of the process flow based on a result of the workability evaluation, and outputs information presenting the maintenance range, the process flow and the work time.

### CLAIM OF PRIORITY

The present application claims priority from Japanese patent application JP 2019-094868 filed on May 20, 2019, the content of which is hereby incorporated by reference into this application.

### Technical Field

The present invention relates to a device and method for generating a process flow for maintenance of a plant.

### Background Art

A plant such as a petroleum refining plant, an organic material plant and a power plant includes reaction machines for production, pipes that carry materials, intermediate products, products, waste and the like, and valves and pumps that control a flow of the pipe. The pipes are connected to each other by a component such as a joint.

Operation of the plant deteriorates these machines and pipes. The machines are maintained in accordance with production, for example, for a purpose of preventing breakdown or maintaining quality. Deterioration of the pipes is caused by corrosion or the like depending on an environment such as a flow rate, a flow velocity, a fluid and a temperature, and the pipes are reduced in thickness over time of use. Inspection is executed and replacement maintenance are required due to impact on productivity and quality, risk of damage and accident, and the like.

Deterioration of an outer surface of the pipe can be determined, for example, by visual observation of a maintenance worker, but deterioration of an inner surface cannot be visually observed. When the plant is in operation and a flow is in the pipe, dismantling inspection cannot be executed. Therefore, it is necessary to periodically execute the replacement maintenance according to previously designed life setting of the pipe. In the maintenance plan, a maintenance process is determined for a range of collected pipes in the plant over a long period such as several years or more. A maintenance method is scheduled maintenance.

Means for evaluating a thickness reduction amount of the pipe includes a computer-aided engineering (CAE) analysis technology and a measurement technology using an ultrasonic wave and a laser, and an engineering service for thickness reduction evaluation has become widespread in recent years. According to these technologies, the thick reduction amount, that is pipe thickness at the time of evaluation is known, so that a remaining life serving as a period up to a usage limit of the pipe can be predicted based on the thickness reduction amount due to previous use.

Condition-based maintenance (CBM), which is a method of maintenance by monitoring a state of equipment, and predictive maintenance, in which maintenance is executed before breakdown occurs when an abnormality is detected by monitoring sensor information and the like, have been known. These are methods of avoiding unnecessary maintenance work by periodically executed maintenance and preventing the breakdown. If the remaining life can be predicted by the thickness reduction evaluation of the pipe, the maintenance can be planned according to the remaining life, so that unnecessary periodic maintenance can be avoided and the risk of accident or the like can be prevented.

The plant is a construction such as a building, or a larger structure. As construction work needs a crane and a stage, the maintenance also needs the crane and the stage. Even when the thickness reduction of the pipe is inspected, the stage may be required in order to reach the target pipe. Since the pipe is long and connected and must be emptied during the maintenance, it is necessary to stop running of a system line simultaneously. For a complicated structure of the pipe, it is necessary to evaluate workability of setup, dismantling and construction. For this purpose, pipe and machine information, pipe connection information and three-dimensional position information in CAD of the plant are utilized.

On the other hand, from a viewpoint of work, even when only one pipe having a short remaining life is replaced, the stage and the crane are necessary, resulting in high cost. Since the system line needs to be stopped, compared with maintaining individually, collectively maintaining adjacent pipes simultaneously can reduce the cost in terms of setup and prevent productivity from decreasing due to the stop of the system line.

A plant construction support device in Patent Literature 1 groups CAD components of an existing plant based on function, space and design information and creates a corresponding process template. A technology is proposed in which CAD components of a new plant are grouped, which is determined to be similar to CAD component grouping of the existing plant, and a process for the new plant is generated.

Patent Literature 2 proposes a pipe maintenance system for obtaining information on a stage to be installed in order to execute inspection on a plurality of pipes constituting a plant. This is a technology in which based on inspection items and inspection plan for each pipe, and three-dimensional position information of the pipe, the stage at the time of inspection is displayed three-dimensionally and interference between the stage and the pipe is checked.

### Prior Art Literature

### Patent Literature

PTL 1: JP-A-2012-230586

PTL 2: JP-A-2015-125523

### SUMMARY OF INVENTION

### Technical Problem

CAD data is utilized to evaluate necessity of a setup process such as installation of a stage and a crane is required for a complicated pipe structure of a plant, and to evaluate maintenance workability of dismantling and construction. Then, an object is to design a maintenance process flow for pipes as maintenance targets determined based on remaining life prediction by collecting pipe line ranges and integrating setup and maintenance workability. If the maintenance process flow is determined, a schedule and cost can be evaluated by executing the schedule to be expanded to an actual schedule.

In Patent Literature 1, a process for the new plant is generated based on component grouping of the plant constructed in the past, and a process of partial maintenance of a plant such as pipes and system lines instructed by the remaining life prediction cannot be generated.

Although a stage construction position in the inspection can be determined by the technology disclosed in Patent Literature 2, there is no proposal for workability evaluation in the inspection. In pipe maintenance of the plant, a process needs to be designed by integrating the evaluation of setup and maintenance workability, and thus the maintenance process cannot be designed only by constructing the stage. In addition, the process cannot be designed only by selecting the crane or evaluating the workability. A means for integrating setup and maintenance workability is required.

An object of the invention to provide a technology for automatically designing a maintenance process flow for a plant based on a prediction result of a remaining life of a pipe.

### Solution to Problem

A representative example of the invention disclosed in the present application is as follows. That is, a maintenance process flow generation device is configured to generate a maintenance process flow for a plant including a plurality of pipes and a plurality of machines as elements. The maintenance process flow generation device includes: a processor; a storage device connected to the processor; and an interface connected to the processor. The maintenance process flow generation device holds configuration information on the plurality of elements included in a target plant, connection of the plurality of elements and coordinates of the plurality of elements, life information on life of each of the plurality of pipes, and master process flow information defining an order relationship of processes serving as maintenance work, specifies a target pipe based on the life information, extracts a maintenance range that is a combination of the elements as maintenance targets including the target pipe based on the configuration information, determines necessity of a process required for maintenance on the plurality of elements that is capable of being collectively maintained based on the configuration information, generates a process flow defining the order relationship of the processes executed in the maintenance of the target plant based on a result of the process necessity determination and the master process flow information, evaluates workability of the process included in the process flow based on the configuration information, calculates work time of the process flow based on a result of the workability evaluation, and outputs information presenting the maintenance range, the process flow and the work time.

### Advantageous Effect

According to the invention, the maintenance process flow for the plant can be automatically designed based on the prediction result of the remaining life of the pipe. Problems, configurations and effects other than those described above will become apparent from the following description of the embodiments.

### BRIEF DESCRIPTION OF DRAWINGS

FIG. 1 is a flowchart showing an example of design processing of a maintenance process flow executed by a computer system according to a first embodiment.

FIG. 2 is a view showing an example of a configuration of the computer system according to the first embodiment.

FIG. 3 is a view showing requirements for implementing a system for generating a maintenance plan.

FIG. 4 is a view showing a flow of data in processing executed by a maintenance process flow design system according to the first embodiment.

FIG. 5 is a view showing an example of a structure of a plant defined by configuration information according to the first embodiment.

FIG. 6A is a diagram showing an example of a process flow generated by the maintenance process flow design system according to the first embodiment.

FIG. 6B is a diagram showing an example of a process flow generated by the maintenance process flow design system according to the first embodiment.

FIG. 7 is a diagram showing a list of constraints used by the maintenance process flow design system according to the first embodiment.

FIG. 8 is a diagram showing a relationship between the processing executed by the maintenance process flow design system according to the first embodiment and the constraints.

FIG. 9 is a view showing an example of a P&ID.

FIG. 10A is a diagram showing an example of a data structure of the configuration information according to the first embodiment.

FIG. 10B is a diagram showing an example of the data structure of the configuration information according to the first embodiment.

FIG. 11 is a diagram showing an example of a data structure of remaining life information according to the first embodiment.

FIG. 12 is a diagram showing an example of a data structure of master process flow information according to the first embodiment.

FIG. 13A is a diagram showing an example of the master process flow information according to the first embodiment.

FIG. 13B is a diagram showing the example of the master process flow information according to the first embodiment.

FIG. 13C is a diagram showing the example of the master process flow information according to the first embodiment.

FIG. 14 is a view showing an example of a data structure of system line semantic information according to the first embodiment.

FIGS. 15A to 15E are views showing an example of connection between pipes and machines.

FIGS. 16A to 16B are views showing a method of specifying a flow path according to the first embodiment.

FIGS. 17A to 17B are views showing a relationship between an edge and a node.

FIGS. 18A to 18C are views showing a method of specifying a path along the pipe according to the first embodiment.

FIGS. 19A to 19B are views showing a state of elements on an outer periphery forming a cyclic path.

FIG. 20 is a diagram showing an example of a definition of a height range.

FIG. 21A is a view showing an example of regions surrounded by pipes having different height levels.

FIG. 21B is a view showing the example of the regions surrounded by the pipes having different height levels.

FIG. 22 is a view showing an example of a positional relationship between a crane and a pipe.

FIG. 23 is a view showing an example of an arrangement of the crane with respect to a maintenance range.

FIG. 24A is a view showing an example of a region including a pipe.

FIG. 24B is a view showing the example of the region including the pipe.

FIG. 25 is a view showing a concept of a method for evaluating a workable region.

FIGS. 26A to 26C are views showing an example of the workable region.

FIGS. 27A to 27C are views showing an example of how to determine the region including the pipe.

FIG. 28A shows a configuration of data for managing work space constraints.

FIG. 28B shows a configuration of data for managing the work space constraints.

FIG. 28C shows a configuration of data for managing the work space constraints.

FIG. 28D shows a configuration of data for managing the work space constraints.

FIG. 29 is a flowchart showing an example of design processing of a maintenance process flow executed by a computer system according to a second embodiment.

FIG. 30 is a view showing an example of a business model utilizing the computer system described in the first or second embodiment.

### DESCRIPTION OF EMBODIMENTS

### First Embodiment

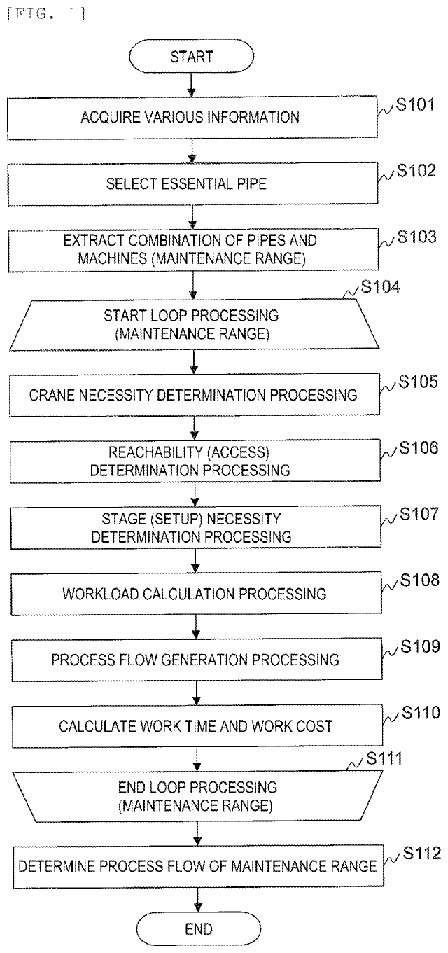

FIG. 1 is a flowchart showing an example of design processing of a maintenance process flow executed by a computer system according to a first embodiment. FIG. 2 is a view showing an example of a configuration of the computer system according to the first embodiment.

The computer system is a system for generating a maintenance plan (the maintenance process flow), and includes a maintenance process flow design system 201, a scheduling system 202, and an operation and maintenance (O&M) simulator 203.

The maintenance process flow design system 201, the scheduling system 202 and the O&M simulator 203 are implemented using, for example, a computer including a processor 205, a memory 206 and a network interface 207. The maintenance process flow design system 201, the scheduling system 202 and the O&M simulator 203 may be implemented using a plurality of computers.

The processor 205 executes a program stored in the memory 206. The processor 205 operates as a functional unit (a module) that implements a specific function by executing processing according to the program. In the following description, when the processing is described in terms of the functional unit, it is indicated that the processor 205 is executing the program that implements the functional unit.

The memory 206 stores the program executed by the processor 205 and information used by the program. The memory 206 includes a work area used by the program.

The network interface 207 is an interface that communicates with an external device via a network. The network is, for example, a local area network (LAN) and a wide area network (WAN).

The computer may include a storage device such as a hard disk drive (HDD) and a solid state drive (SSD), an input device such as a keyboard and a mouse, and an output device such as a display.

The maintenance process flow design system 201, the scheduling system 202 and the O&M simulator 203 generate a process flow for a combination of pipes and machines in a plant.

The scheduling system 202 generates a schedule for maintenance work based on the process flow. That is, a maintenance plan is generated. The scheduling system 202 may evaluate the generated schedule.

The O&M simulator 203 determines quality of execution of the maintenance work from a viewpoint of plant operation such as productivity of a plant and cost of the maintenance work.

Here, the processing executed by the maintenance process flow design system 201 will be described.

The maintenance process flow design system 201 acquires various information necessary for generating the process flow (step S101).

For example, information on the pipes and machines in the plant, information on life of the pipe, information on maintenance execution period, information on a process to be executed, information on equipment used in the process, and an algorithm (a calculation equation) for calculating an evaluation value of the process are acquired.

The information on the pipes and machines in the plant includes elements (the pipes and machines) present in the plant, connection relationships between the elements, coordinates of the elements, and the like. These pieces of information can be acquired from, for example, three-dimensional CAD data.

The information on the life of the pipe includes a predicted value of remaining life of the pipe. The predicted value of the remaining life of the pipe is calculated using a known technology.

The information on the maintenance execution period includes a period during which maintenance is executed, and the like. The information is used to specify a pipe as a maintenance target. For example, when the maintenance execution period is one month and half a year from now on, the pipe whose remaining life is shorter than half a year is specified as the maintenance target after one month. The information may not be a specific value, but may be set as an algorithm for realizing calculation processing for allocating the maintenance period based on the predicted value of the remaining life of the pipe.

The information on the process to be executed includes definitions of a content and an order of the process.

The information on the equipment used in the process includes performance and a size of the equipment such as a crane, a cutting machine and a welding machine. For example, a height, a moving distance and the like that the crane can reach are included. Cutting performance and the like of the cutting machine can be used as parameters used to calculate a work time. Thereby, the process in consideration of the work time can be generated.

The algorithm for calculating the evaluation value of the process includes an equation for calculating the work time. The equation is defined by parameters indicating maintenance construction capability, execution capability, a load and the like.

Next, the maintenance process flow design system 201 selects an essential pipe requiring maintenance (step S102).

For example, when the maintenance execution period is given, the maintenance process flow design system 201 selects a pipe whose life is likely to end during that period as the essential pipe. When the algorithm for calculating the maintenance execution period based on the remaining life of the pipe is given, the maintenance process flow design system 201 selects a pipe corresponding to the remaining life referred to during calculation as the essential pipe.

Next, the maintenance process flow design system 201 extracts the combination of the pipes and machines (a maintenance range) as maintenance targets (step S103).

Specifically, the maintenance process flow design system 201 extracts the maintenance range by combining a system line including the essential pipe, and the machine, the pipe and other system lines attached to the system line based on pipe constraints described below. Here, a plurality of maintenance ranges are extracted.

The maintenance process flow design system 201 may extract a maintenance range excluding system lines including pipes other than the essential pipe.

Processing from step S104 to step S111 are loop processing of the maintenance range. First, the maintenance process flow design system 201 selects a target maintenance range (step S104).

Next, the maintenance process flow design system 201 executes crane necessity determination processing (step S105).

Specifically, the maintenance process flow design system 201 determines whether the crane is necessary in the maintenance work, based on work space constraints described below.

For example, if the maintenance work is only an inspection, it is determined that the crane is unnecessary. When the pipe or the machine is at a high place, when the pipe or the machine is large or when the pipe or the machine is heavy, it is determined that the crane is necessary.

Next, the maintenance process flow design system 201 executes reachability (access) determination processing (step S106).

Specifically, the maintenance process flow design system 201 determines whether a worker or the crane can reach the pipe or the machine included in the maintenance range, based on reachability constraints and the work space constraints.

For example, when the worker accesses the pipe within the maintenance range surrounded by high and large pipes, installation of a ladder or a stage is necessary. When the pipe is at the high place, construction of the stage is necessary.

For example, when the crane is necessary, there must be no obstacle at an installation position in order to install the crane at a position where a hanging bracket can reach the pipe. The maintenance process flow design system 201 determines whether a predetermined crane can access the pipe in a region where the crane can be installed or determines a specification of the crane that can access the pipe.

Next, the maintenance process flow design system 201 executes stage necessity determination processing (step S107).

Specifically, the maintenance process flow design system 201 determines whether the installation of the stage is necessary for maintenance, based on the reachability constraints and the work space constraints.

For example, when the pipe is at a position where work cannot be executed on the ground, such as when the pipe is at the high place, the installation of the stage is necessary. Since the stage is constructed in a stepwise manner, a plurality of levels of stages are installed when the pipe is at the high place. In order to maintain a pipe immediately above a pipe on which the stage is installed, a new stage may be installed on the stage. If stages are installed simultaneously in a specific range, maintenance of horizontally connected pipes or adjacent pipes can reduce labor, cost and the like required for installation of the stages.

Next, the maintenance process flow design system 201 executes workload calculation processing (step S108).

Specifically, the maintenance process flow design system 201 specifies a process to be executed in the target maintenance range, based on processing results from step S105 to step S107. The maintenance process flow design system 201 calculates or specifies parameter values for evaluating workability of a specified process based on the work space constraints described below.

Next, the maintenance process flow design system 201 executes process flow generation processing (step S109).

Specifically, the maintenance process flow design system 201 generates a process flow for the maintenance range by determining an execution order of processes, based on master process flow information 234 described below.

For example, the process flow for maintenance of the pipe at the high place includes constructing the stage, attaching the hanging bracket of the crane to the pipe, dismantling the pipe, removing the pipe, detaching the hanging bracket, attaching the hanging bracket to a replacement pipe, constructing the replacement pipe, detaching the hanging bracket, and dismantling the stage.

Next, the maintenance process flow design system 201 calculates work time and work cost of the process flow (step S110).

Specifically, the maintenance process flow design system 201 calculates the work time of each process included in the process flow based on the parameter values calculated or specified in step S108 based on the algorithm (the equation), and calculates a sum of the work time of each process as a work time of the process flow. The maintenance process flow design system 201 calculates the work cost by multiplying the work time of the process flow by a work unit price. Regarding the process related to the use of the equipment, equipment specific cost may be added.

Next, the maintenance process flow design system 201 determines whether processing has been executed for all maintenance ranges (step S111).

When it is determined that the processing has not been executed for all the maintenance ranges, the maintenance process flow design system 201 returns to step S104 and executes the same processing.

When it is determined that the processing has been executed for all the maintenance ranges, the maintenance process flow design system 201 determines a process flow to be output to the scheduling system 202 from process flows of the maintenance ranges (step S112).

For example, when the process flow is determined based on the cost, the maintenance process flow design system 201 sorts the process flows of the maintenance ranges in an ascending order of the work costs, and outputs the process flow of the maintenance range having the lowest work cost to the scheduling system 202.

The maintenance process flow design system 201 may present a user with a list of all the process flows or a list of process flows satisfying any condition. In this case, the user refers to the list to determine a process flow based on viewpoints of budget, the number of steps, the number of days, and the like.

The information and the program may be acquired at any timing. A processing order of the workload calculation processing and the process flow generation processing may be interchanged or may be executed simultaneously.

Next, a functional configuration of the maintenance process flow design system 201 will be described.

The maintenance process flow design system 201 includes, as functional units, an information acquisition unit 211, an essential pipe selection unit 212, a process planner 213, an evaluation value calculation unit 214 and a process flow selection unit 215.

The maintenance process flow design system 201 holds configuration information 231, remaining life information 232, equipment information 233, master process flow information 234, work time calculation equation information 235, system line semantic information 241, pipe connection information 242, flow path information 243, cyclic path information 244, accessibility (graph) information 251, accessibility (worker) information 252, height range information 253, pipe surrounding region information 254, pipe region information 261, and workable region information 262, pipe size information 263 and pipe density information 264.

The configuration information 231 is information for managing a configuration of the pipes and machines in the plant. The remaining life information 232 is information for managing the life of the pipe. The equipment information 233 is information for managing a size, performance and the like of the equipment such as the crane.

The master process flow information 234 is information for managing a definition of an order relationship of the processes. The work time calculation equation information 235 is information for managing a work time calculation equation for calculating the work time of the process.

The system line semantic information 241 is information for managing connection between the pipes and machines for realizing a specific application or function, such as a reaction furnace, raw material supply and product output, as a system line.

The pipe connection information 242 is information for managing a constraint on pipe connectivity.

The flow path information 243 is information for managing a constraint on a flow path.

The cyclic path information 244 is information for managing a constraint on a path along the pipe.

The accessibility (graph) information 251 is information for managing a constraint on accessibility (graph).

The accessibility (worker) information 252 is information for managing a constraint on accessibility (worker).

The height range information 253 is information for managing a constraint on an overlap of ranges having different heights.

The pipe surrounding region information 254 is information for managing a constraint on a region around the pipe.

The pipe region information 261 is information for managing a constraint on a region including the pipe.

The work region information 262 is information for managing a constraint on a workable region.

The pipe size information 263 is information for managing a constraint on a size of the pipe.

The pipe density information 264 is information for managing a constraint on density of the pipes.

In the following description, the system line semantic information 241, the pipe connection information 242, the flow path information 243, the cyclic path information 244, the accessibility (graph) information 251, the accessibility (worker) information 252, the height range information 253, the pipe surrounding region information 254, the pipe region information 261, the workable region information 262, the pipe size information 263 and the pipe density information 264 are collectively described as constraint information.

The information acquisition unit 211 is a functional unit that acquires various information. Specifically, the information acquisition unit 211 acquires the configuration information 231, the remaining life information 232, the equipment information 233, the master process flow information 234 and the work time calculation equation information 235.

The information acquisition unit 211 acquires information via an external system or a terminal connected to the maintenance process flow design system 201. The invention is not limited to the format of data to be acquired. For example, data in a text format or CSV format may be converted into a predetermined data format and stored. The information acquisition unit 211 may not acquire information at a time. For example, when predetermined information is necessary, the information acquisition unit 211 may acquire the information.

The essential pipe selection unit 212 is a functional unit that selects the essential pipe based on the remaining life information 232.

The process planner 213 is a functional unit that extracts the maintenance range based on various constraints and generates the process flow of the maintenance range. The process planner 213 includes a maintenance range extraction unit 221, a crane necessity determination unit 222, a reachability determination unit 223, a stage necessity determination unit 224, a workload calculation unit 225 and a process flow generation unit 226.

The maintenance range extraction unit 221 is a functional unit that extracts the maintenance range based on the configuration information 231 (particularly information on connection between the pipes and machines and between the pipes), the essential pipe, the system line semantic information 241, pipe connection information 242, flow path information 243 and cyclic path information 244.

The crane necessity determination unit 222 is a functional unit that determines whether the crane is necessary based on the configuration information 231 (particularly information on weights, sizes and arrangements of the pipes and machines).

The reachability determination unit 223 is a functional unit that determines reachability of the worker and the crane with respect to the maintenance range. Specifically, the reachability determination unit 223 determines whether the worker can reach the machine and the pipe included in the maintenance range based on the configuration information 231 (particularly information on the connection between the pipe and the machine and between the pipes, and positions thereof) and the accessibility (worker) information 252. The reachability determination unit 223 determines whether the crane can reach the machine and the pipe included in the maintenance range based on the configuration information 231 (particularly the information on the connection between the pipe and the machine and between the pipes, and positions thereof), the accessibility (graph) information 251, the height range information 253 and the pipe surrounding region information 254.

The stage necessity determination unit 224 is a functional unit that determines whether the stage is necessary based on the configuration information 231 (particularly information on the connection and the positions of the pipes) and the height range information 253. For example, whether the stage is necessary is determined so that the stage for pipes having different heights or the stage for adjacent pipes is shared. Regarding the pipe installed at the high place, necessity of the stage at a low position is determined.

The workload calculation unit 225 is a functional unit that calculates various parameter values to be substituted into a calculation equation based on the configuration information 231, a processing result of the crane necessity determination unit 222, a processing result of the stage necessity determination unit 224, the pipe region information 261, the workable region information 262, the pipe size information 263 and the pipe density information 264.

The process flow generation unit 226 is a functional unit that generates the process flow based on the configuration information 231, the master process flow information 234, the processing result of the crane necessity determination unit 222 and the processing result of the stage necessity determination unit 224.

The process planner 213 has been described as above.

The evaluation value calculation unit 214 is a functional unit that calculates the evaluation value of the process flow of each maintenance range based on the parameter values calculated by the workload calculation unit 225. Specifically, the evaluation value calculation unit 214 calculates the work time of the process flow of each maintenance range based on the parameter values calculated by the workload calculation unit 225. The evaluation value calculation unit 214 calculates the work cost based on the work time, the work time unit price and process unique information.

The process planner 213 and the evaluation value calculation unit 214 are separately configured, assuming that the work time of the process flows of the plurality of maintenance ranges is calculated, but the invention is not limited thereto. For example, the evaluation value calculation unit 214 may be included in the workload calculation unit 225 of the process planner 213 or in the process planner 213.

The process flow selection unit 215 is a functional unit that selects the process flow. For example, the process flow selection unit 215 selects the process flow based on the work cost. The process flow may be selected based on a processing result of the scheduling system 202 or the O&M simulator 203.

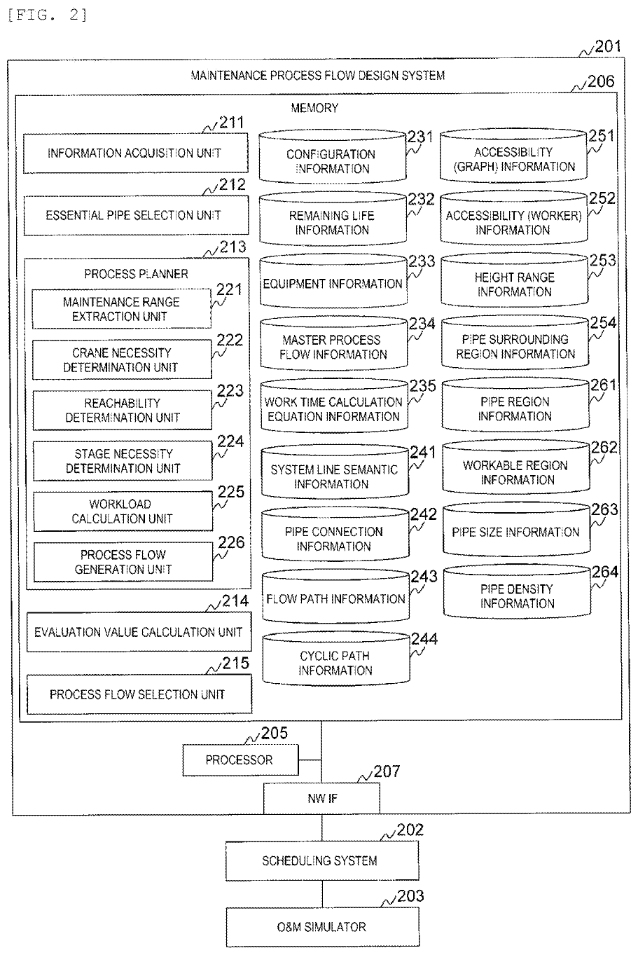

Next, a method and a technology required to implement a system for generating a maintenance plan based on the remaining life of each pipe calculated based on an evaluation result of deterioration of the pipe in plant O&M will be described. FIG. 3 is a view showing requirements for implementing the system for generating the maintenance plan. In FIG. 3, a square indicates processing, an arrow indicates a flow of the processing, and a balloon indicates data obtained by the processing.

Here, it is assumed that the plant is designed using CAD 300. Design information (CAD data) of the plant designed using the CAD 300 includes a list of elements (the pipes and machines), shapes and positions of the elements, and data indicating connection relationships between the elements, and the like.

A subject of the processing described below is a computer. The computer that executes each process may be the same or different.

The computer executes data extraction processing in order to extract data required to predict the remaining life of the pipe and to generate the maintenance plan based on the design information of the plant (P310).

A technology for extracting information specifying the process is required. For example, by using a known technology, a piping & instrumentation flow diagram (P&ID) and three-dimensional coordinate information can be acquired as a processing result from the design information of the plant. The P&ID is also referred to as a piping instrumentation diagram.

Here, the P&ID means information indicating the list of elements in the plant and the connection relationships between the elements, and does not represent a specific data format or file format. The three-dimensional coordinate information may include information calculated from coordinate values such as dimensions.

The computer executes remaining life prediction processing using the P&ID and the three-dimensional coordinate information (P320).

A technology for predicting the remaining life is required. More specifically, a corrosion model is required in order to predict the remaining life due to deterioration such as corrosion of the pipe. This may use an analysis model for computer-aided engineering (CAE) simulation obtained from a physical theory, or a statistical model reflecting actual data and theoretically derived variations. When the remaining life of the pipe is predicted, it is necessary to refer to actual pipe inspection results and maintenance results. As a result of the remaining life prediction processing, the remaining life of each pipe can be acquired.

The computer executes extraction processing of the maintenance range (the combination of the pipes and machines) based on the P&ID, the three-dimensional coordinate information and the remaining life of each pipe (P330).

A technology for extracting the maintenance range for implementing efficient and effective maintenance work is required. Therefore, in the first embodiment, pipe connection constraints are defined in order to extract the maintenance range. The computer extracts the maintenance range based on the pipe connection constraints. Processing of step S103 corresponds to maintenance range extraction processing.

The computer executes process necessity determination processing and workability evaluation processing by combining the maintenance range and a work region (P340).

A technology for specifying the process required for maintenance in the maintenance range and a technology for evaluating workability in the maintenance range are required. Therefore, in the first embodiment, the reachability constraints and the work space constraints are defined in order to implement process specification and workability evaluation. The computer specifies a necessary process based on the reachability constraints and the work space constraints, and calculates the parameter values for calculating the work time of the process. Processing from step S105 to step S107 corresponds to the process necessity determination processing, and processing of step S108 corresponds to the workability evaluation processing.

The computer executes the process flow generation processing based on the specified process (P350).

A technology for determining contents of a specific process and determining the order of the processes is required. Therefore, in the first embodiment, the master process flow information 234 that defines the contents and an order relationship of the processes and a collective relationship of the processes are set. Processing of step S109 corresponds to the process flow generation processing.

The computer may refer to the master process flow information 234 in the process necessity determination processing when the processes are collected in process necessity determination.

The computer executes work time calculation processing based on the P&ID and the three-dimensional coordinate information, and the parameter values calculated by the process necessity determination processing and the workability evaluation processing (P360).

A technology for parameterizing construction capacity of the process and an algorithm for calculating the work time are required. In the first embodiment, the parameter values for evaluating the workability is calculated in P350, and the work time is calculated based on the algorithm described below. The parameter values may be directly calculated based on the P&ID and the three-dimensional coordinate information. Processing of step S110 corresponds to the work time calculation processing.

The computer executes maintenance plan design processing and maintenance plan evaluation processing using the work time and the process flow (P370).

It is necessary to define a key performance indicator (KPI) for evaluating the maintenance plan. By this processing, the maintenance plan including the process, a schedule and the like, and the KPI such as maintenance cost are output. The user can compare the maintenance plan based on the output.

The computer can also present a list in which the process flows are sorted according to the work time, the work cost or the like. The user can compare the process flows by referring to the list, generate the maintenance plan from an optimal process flow, and obtain the KPI.

In the first embodiment, a known technology is used for the processing of P310, P320 and P370. The invention described in the first embodiment provides a technology for implementing P330, P340, P350 and P360.

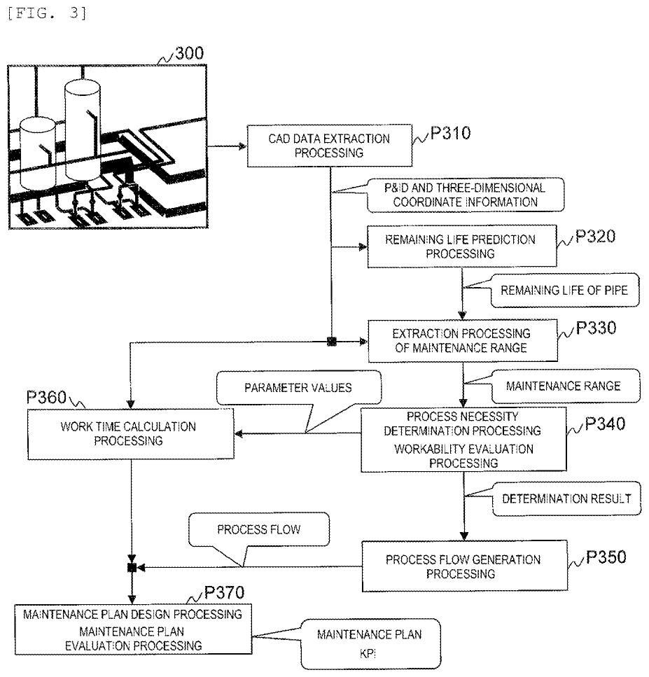

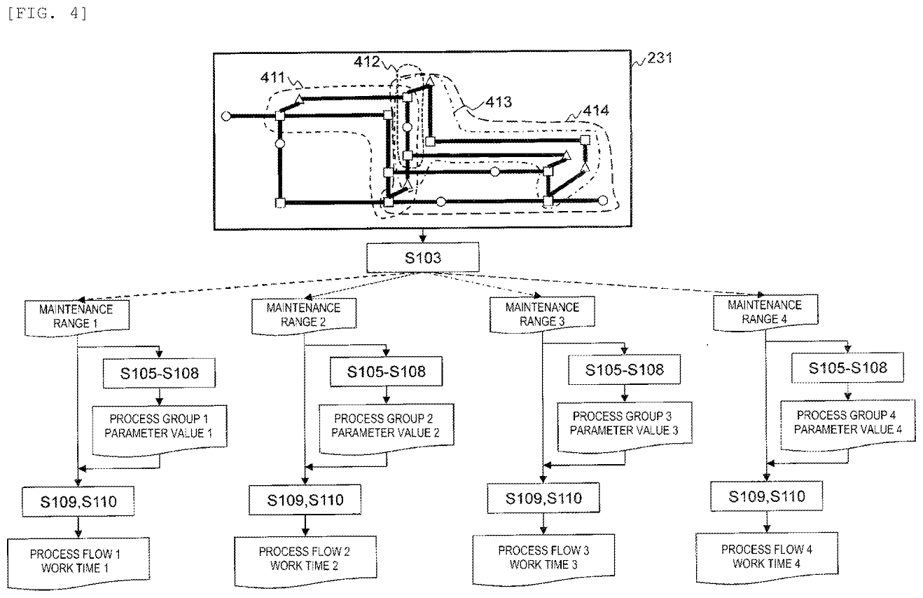

FIG. 4 is a view showing a flow of data in processing executed by the maintenance process flow design system 201 according to the first embodiment. FIG. 5 is a view showing an example of a structure of the plant defined by the configuration information 231 according to the first embodiment. FIGS. 6A and 6B are diagrams showing the example of the process flow generated by the maintenance process flow design system 201 according to the first embodiment.

Here, the configuration information 231 of the plant as shown in FIG. 5 is input. First, an example of the structure of the plant will be described. FIG. 5 is a graph showing arrangement of the machine and the pipe in the plant in a three-dimensional space.

In FIG. 5, a direction from left to right is defined as positive on an x-coordinate axis, a direction from lower to upper is defined as positive on a y-coordinate axis, and a diagonally upper right direction is defined as positive on a z-coordinate axis. Dotted lines form a grid of the x-coordinate and the y-coordinate. A thick solid line represents a pipe, a square represents a joint, a circle represents a valve, and a triangle represents an elbow. The elbow is a joint that is changed by 90 degrees in an upper-lower direction.

In FIG. 5, in order to identify the pipe and the machine such as the joint, the valve and the elbow, a symbol obtained by combining an alphabet letter and a two-digit number is attached. “P” is an identification symbol of the pipe, “J” is an identification symbol of the joint, “V” is an identification symbol of the valve, and “E” is an identification symbol of the elbow.

In the following description, a pipe P16 and a pipe P17 are selected as essential pipes in processing of step S102.

The maintenance process flow design system 201 extracts the maintenance range by executing processing of step S103.

Here, a maintenance range 1 (411), a maintenance range 2 (412), a maintenance range 3 (413) and a maintenance range 4 (414) are extracted.

For example, the maintenance range 1 (411) is a combination of elements J01, P02, J02, P04, J04, P07, J05, P19, E02, P18, J09, P17, V06, P16, J08, P15, E01, P14. The maintenance range 2 (412) is a combination of elements P16, V06, P17, and is a minimum maintenance range including essential pipes P16, P17. Similarly, the maintenance range 3 (413) and the maintenance range 4 (414) are combinations of elements including the essential pipes P16, P17.

The maintenance process flow design system 201 executes processing of steps S105 to S108 based on the reachability constraints and the work space constraints for the maintenance range 1 (411). Thereby, a process group 1 that collects setup and maintenance work of the elements is specified, and a parameter value 1 for evaluating the workability of the process is calculated. The maintenance process flow design system 201 executes the processing of S109 based on the master process flow information 234, and executes the processing of step S110 based on the work time calculation equation information 235. Thereby, a process flow 1 is generated from the process group 1, and work time 1 of the process flow 1 is calculated from the parameter value 1.

The maintenance process flow design system 201 executes the same processing for each of the maintenance range 2 (412), the maintenance range 3 (413), and the maintenance range 4 (414).

The maintenance process flow design system 201 presents a list of the process flows sorted based on a total value or a standard deviation of the work time included in the process flow as information for determining quality of the process flow.

An example of the process flow generated by the maintenance process flow design system 201 is shown in FIGS. 6A and 6B.

The process flow 1 shown in FIG. 6A is the example in which the maintenance execution period is divided into three. A method for generating a process flow as shown in FIG. 6A will be described in a second embodiment. A process flow 2 shown in FIG. 6B is the example in which the same target is maintained once.

In the process flow 1 shown in FIG. 6A, first maintenance work time is 158 hours, second maintenance work time is 204 hours, third maintenance work time is 231 hours, and in the process flow 2 shown in FIG. 6B, once maintenance work time is 334 hours. In the process flow 1, each work time is less than 231 hours, and cost of once maintenance work is low. However, total maintenance work time is 593 hours. On the other hand, the maintenance work time of the process flow 2 is 334 hours, which indicates that cost of maintenance work can be reduced as compared with the process flow 1. By generating the process flow for each maintenance range in this manner, the quality of the process flow can be determined.

Next, the constraints and the processing will be described.

In a design of the maintenance process flow, it is necessary to determine the maintenance target for a plant system and to determine a range for each maintenance execution period. The crane is necessary not only for inspection but also for dismantling and construction. The installation of the stage is also necessary. Work regions can be worked simultaneously and continuously if the work region are collected together or within a close range. The stage can also be used in common.

Setting of the work region affects contents and load of the work. Since all factors are necessary for the design of the maintenance process flow, the constraints for designing the process flow are divided into constraints on pipe connection and constraints on space. Regarding the space, the reachability constraints by which the worker and the crane can work on the pipe, and the work space constraints for evaluating the workability when the work regions are collected have been arranged. In the invention, three constraints on the pipe connection, the reachability and the work space are set as follows.

The pipe constraints include constraints on system line semantics, pipe connectivity, the flow path, and the path along the pipe.

(1) System line semantics: When information indicating semantics of a system line such as a reaction furnace, raw material supply and product output is defined as CAD data as information on the connection between the pipes and machines, it means that the pipes and machines function in series. In the first embodiment, the above-described information is used as a constraint. The constraint is used to select the combination of the pipes and machines to be maintained.

(2) Pipe connectivity: The constraint is used to specify a pipe connected to the essential pipe, that is, an adjacent pipe.

(3) Flow path: The constraint is used to extract connection of a series of flow pipes from a flow direction of the pipes and an input and output relationship of the machine.

(4) Path along pipe: When the work is continuously executed, it is efficient to execute work along the pipe. In particular, in the work such as inspection, it is efficient if the path is a cyclic path that goes around from a start position and returns to the original start position. The constraint is used to obtain the cyclic path.

The reachability constraints include constraints on accessibility (graph), worker accessibility, overlap of ranges having different heights, and the region around the pipe.

(5) Accessibility (graph): It is assumed that the pipe is arranged at the same height as the ground. No mobile crane, truck or the like can be inserted inside the region surrounded by the pipe. Thereby, reachability can be determined based on presence or absence of a maintenance target pipe inside the cyclic path of pipes that is the outermost periphery of pipe connection. The constraint is used to evaluate the reachability based on the outermost cyclic path of pipes.

(6) Worker accessibility: Even in the region surrounded by the pipe, the worker having such a size can pass. When the pipe is large and no gap is between the ground and the pipe, the worker cannot pass. However, even in such a state, if the stage is provided, it is possible to move over the pipe. In addition, the stage is necessary to be provided for the pipe at the high place. The constraint is used to evaluate the reachability based on the connection and height of the pipes that become obstacles before the worker reaches the target pipe. The constraint may be considered as a condition for evaluating difficulty in reaching the pipe although the worker can reach the pipe. The constraint maybe considered as a condition indicating difficulty in reaching the target pipe.

(7) Overlap of ranges having different heights: It is assumed that the pipe at the low place and the pipe at the high place are maintenance targets. The stage is required to have a required height even for the pipe at the low place. Positions of these two pipes in a horizontal direction do not coincide but are close to each other (for example, only about 1 m apart). When the work is executed on the pipes as described above, compared with erecting the stage for the pipe at the low place and the stage for the pipe at the high place separately, it is better to erect the stage for the pipe at the low place in a horizontal range of the pipe at the high place and to erect the stage at the high place higher than that, so that the process of erecting the stage can be shared. That is, work efficiency is increased. The constraint is used to collect the processes using a fact that the ranges (the regions) overlap even if the height is different.

(8) Region around pipe: a location where the crane is installed should be away from the pipe. Therefore, when other pipes are around the maintenance target pipe, the crane is installed outside other pipes. If no maintenance target pipe is within a work radius range from the installation position of the crane, the work cannot be executed. The constraint is used to evaluate a range of the position where the crane can be installed with respect to the maintenance target pipe, or a work radius of the maintenance target pipe and the installation position of the crane.

The work space constraints include constraints on the region including the pipe, the workable region, the size of the pipe, and the density of the pipes.

(9) Region including pipe: Since the work is executed around the pipe, the maintenance workability depends on a state of the region around the pipe. In order to evaluate the region around the pipe, an offset corresponding to the work region is set in a straight forward direction and a right and left direction (a radial direction) of the pipe, and the region including the pipe is set. When no other maintenance target pipe is in the region set based on the predetermined offset, it can be determined that the workability is bad. The constraint is used to evaluate the workability of the work region around the pipe.

(10) Workable region: In the work on the pipe, a breadth of the region on the left and right of the pipe affects the workability. If no other pipe is in the region, the workability is good. On the other hand, when another pipe is near the region, the worker can work only within a range of a distance between the region and the pipe. The constraint is used to evaluate the workability based on the distance from the region to another pipe or area between the region and another pipe.

(11) Size of pipe: An offset region of the pipe or the workable region on the left and right affect the workability. Evaluation on the region for determining the workability is also different depending on the length and size of the pipe. The constraint is used to evaluate the workability by reflecting the size of the pipe.

(12) Density of pipes: When the pipes are arranged close to each other, it is necessary to execute the maintenance collectively since the work region cannot be individually taken. At this time, the density of the target pipes in the work region affects the work efficiency. The workability becomes bad as the number of pipes becomes large in the pipe offset region in the range including the pipe. The constraint is a constraint for evaluating the workability from the number of pipes with respect to the region.

An example of the above constraints is shown in FIG. 7. From the top, a first stage indicates the pipe connection constraints, a second stage indicates the reachability constraints, and a third stage indicates the work space constraints.

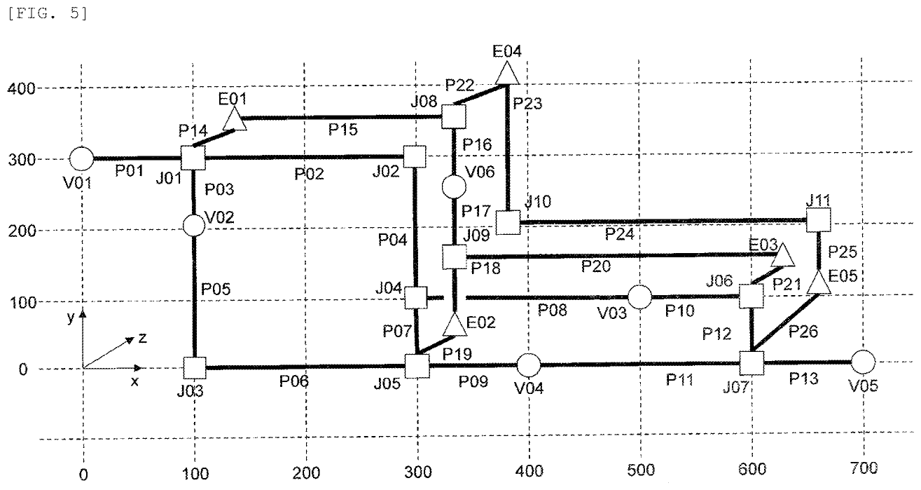

FIG. 8 is a diagram showing a relationship between the processing executed by the maintenance process flow design system 201 according to the first embodiment and the constraints.

A left side of FIG. 8 shows the processing as design processing of the maintenance process flow, and a right side of FIG. 8 shows the constraints. Dashed lines in FIG. 8 indicate the constraints used by the processing. The twelve constraints are classified into three types: the pipe connection constraints, the reachability constraints and work space constraints. The processing having a dashed line connected with a square of a type of constraints indicates that all the constraints included in the type are used. The processing having a dashed line connected with one constraint indicates that the constraint is used.

In the processing of step S103, the pipe constraints are used.

In the processing of step S105, the configuration information 231 and the constraint on the size of the pipe classified into the work space constraints are used. In order to evaluate the work of fixing the hanging bracket of the crane, the work space constraint is used.

In step S106, the reachability constraints and the constraint on the region including the pipe classified into the work space constraints are used. In order to evaluate difficulty of accessing the pipe or the like, the constraint on the region including the pipe is used.

In step S107, the configuration information 231, the constraint on the overlap of the ranges having different heights classified into the reachability constraints and the constraint on the region including the pipe classified into the work space constraints are used. The configuration information 231 is used to specify the height of the pipe, and the constraint on the overlap of the ranges having different heights is used to determine an overlap of stage regions. Since all pipes at the same height close to each other may be worked on simultaneously, the constraint on the region including the pipe is also used in order to determine the overlap of the stage regions.

In step S108, the configuration information 231 and the work space constraints are used. The configuration information 231 is used since the size and weight of elements as maintenance targets affect ease of the work.

A series of processing contents of the maintenance process design has been described as above.

Next, the master process flow and a definition of a calculation equation of the work time will be described. This corresponds to descriptions of the P&ID and the three-dimensional coordinate information that are output of the data extraction processing, the remaining life of the pipe which is output of the remaining life prediction processing, a definition of the master process flow used in the process flow generation processing, parameters used in the work time calculation processing and the definition of the calculation equation of the work time.

FIG. 9 is a view showing an example of the P&ID. The P&ID shown in FIG. 9 is an example for indicating information required in the present specification.

In FIG. 9, a pipe is represented by Pipe, a pump is represented by Pump, a valve is represented by Valve, a flow right is represented by F, a thermometer is represented by T, and a pressure gauge is represented by P. The numbers are identifiers for the aforementioned elements. An element connected to an external system line is represented by BND (Boundary). A stripper is represented by Stripper, feed is represented by a Feed, a water stream is represented by Stream, an exhaust is represented by Ex, and a product is represented by Product. Instruments such as a flow meter, the thermometer, and the pressure gauge are drawn out of a pipe for graphical representation. This drawing is referred to as Line. Since the instrument is installed directly on the pipe, the instrument may be used as attribute information of the pipe.

In FIG. 9, one arrow does not mean one pipe. A Pipe 1 (901) is a series of arrows from a BND (914) to a Stripper (911). A Pipe 2 (902) is an arrow from the Stripper (911) to branch joint (920). A Pipe 3 (903) is a series of arrows from the branch joint (920) to a Product (918). A Pipe 4 (904) is a series of arrows from a Feed (915) to the Stripper (911). A Pipe 5 (905), a Pipe 6 (906), and a Pipe 7 (907) are each indicated by one arrow. A Pipe 8 (908) is a series of arrows from an inflow Stream (916) to an element (921). A Pipe 9 (909) is a series of arrows from the Stripper (911) to a branch joint (919). A Pipe 10 (910) is a series of arrows from a BND (913) to a BND (912).

If pipes connected by a valve, a pump or a joint are divided into connection units, connection relationships between each machine and the pipe can be identified for each element. FIG. 9 shows only configuration of the elements and the connection relationships, and the pipe itself is not necessarily bent as the arrow is bent, and the pipe may be bent even if the arrow is straight.

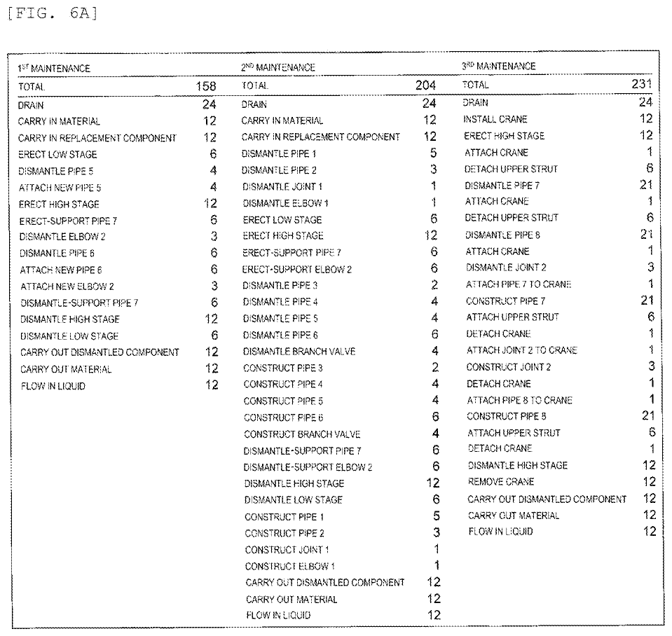

Three-dimensional coordinates used in the process flow generation processing are directly acquired from three-dimensional CAD data. The connection relationship between elements such as the pipes and machines is acquired from the P&ID as shown in FIG. 9. By integrating the three-dimensional coordinates and the connection relationships of the elements, the configuration information 231 including tables 1000 and 1010 as shown in FIGS. 10A and 10B can be generated.

The table 1000 is a table for managing the pipes, and stores entries each including an ID 001, a type 1002, a diameter 1003, a thickness 1004, a length 1005, a material 1006, a start point element 1007 and an end point element 1008. One entry is for one pipe.

An ID 1001 is a field for storing identification information uniquely identifying a pipe. The ID 1001 stores a combination of a symbol P and a number.

The type 1002, the diameter 1003, the thickness 1004, the length 1005 and the material 1006 are information on a structure of the pipe, and are fields for storing a type, a diameter, a thickness, a length and a material of the pipe. In the present embodiment, a weight of the pipe is calculated based on the diameter, the thickness, the length and the material. A field for storing the weight of the pipe may be included in the entry.

The start point element 1007 and the end point element 1008 are fields for storing a combination of the machine identification information indicating directions of flow in and out. The coordinates of the pipe can be specified by combining the start point element 1007, the endpoint element 1008, and the table 1010.

It is assumed that the pipe is straight in a length direction, and bending of the path is realized by being connected to the machine by means such as a joint, an elbow or a T-branch. In a case of handling a bent pipe, for example, a field for storing a coordinate value of a bent portion may be included in the entry.

The table 1010 is a table for managing the machines, and stores entries each including an ID 1011, a type 1012, a weight 1013, an X coordinate 1014, a Y coordinate 1015 and a Z coordinate 1016. One entry is for one machine.

The ID 1011 is a field for storing identification information uniquely identifying a machine. The ID 1011 stores a set of a symbol and a number. A symbol representing an input device is SRC, a symbol representing an output device is SNK, and a symbol representing a valve is VLV.

The type 1012 and the weight 1013 are fields for storing a type and a weight of the machine.

The X coordinate 1014, the Y coordinate 1015 and the Z coordinate 1016 are fields for storing the three-dimensional coordinates of the machine.

A remaining life of the pipe calculated using the P&ID and the three-dimensional coordinates is managed as the remaining life information 232 in a data format as shown in FIG. 11.

The remaining life information 232 stores entries each including an ID 1101 and a remaining life 1102. One entry is for one pipe.

The ID 1101 is a field the same as the ID 1001. The remaining life 1102 is a field for storing the remaining life of the pipe. The remaining life 1102 stores a period or the number of days during which the pipe cannot be used due to deterioration.

Next, the master process flow will be described. The processes executed in the maintenance work include dismantling and constructing the element, installing and dismantling the stage, work by the crane, installing and removing the crane, and stopping and restoring of the system lines required for maintenance.

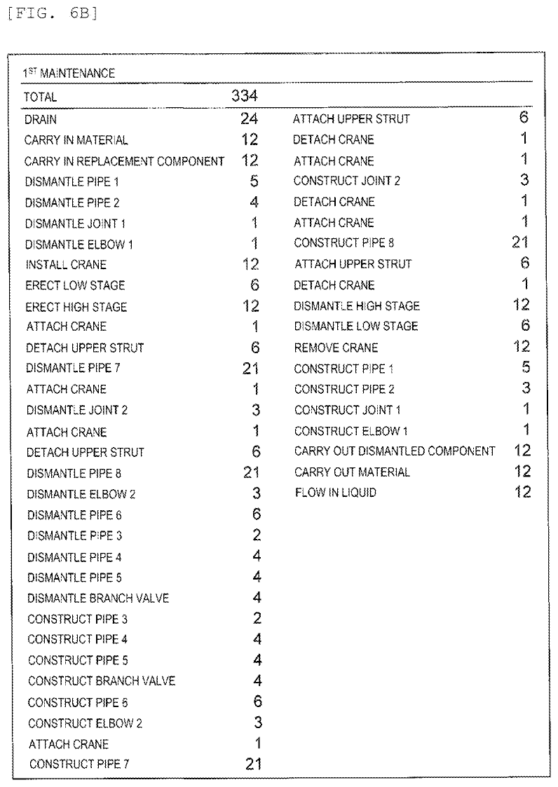

Necessity of the process related to the crane depends on a height of an installation location of the element, a weight of the element and the like. Necessity of the process related to the stage depends on the height of the installation location of the element. Therefore, as information of the process defined in the master process flow, a type, an element and a height of the process (work) are main items. FIG. 12 is a diagram showing an example of a data structure of the master process flow information 234 according to the first embodiment.

Data 1200 is data defining one process, and includes a process name 1201, a component name 1202, a height level 1203, a unique work time 1204, and a height level determination 1205.

The process name 1201 is a field for storing a name of the process. The component name 1202 is a field for storing a type of the element. A process in which the component name 1202 is blank indicates that the process is not related to a component.

The height level 1203 is a field for storing information indicating a height of the process. In the present embodiment, a range of the height is classified by level. For example, a range of 5 m or larger and smaller than 10 m is set as LEVEL 2. A level is stored in the height level 1203. A process in which the height level 1203 is blank indicates that the process is not related to the height.

The unique work time 1204 is a field for storing a time unique to the work. For example, when the crane is installed, the time required for installation is determined by a type of the crane. The time related to preparation work and setup work for executing the work is also set in the field.

The height level determination 1205 is a field for storing information for determining whether the process corresponding to the height level is necessary. For example, in the data defining the process in which the crane is unnecessary when the height level is LEVEL1 and the crane is necessary when the height level is LEVEL2, “LEVEL2” is set in the height level determination 1205. Thereby, a step of installing the crane can be inserted into the process flow. When the stage is at LEVEL2, a stage is also required for LEVEL1 below the stage, so installation and dismantling of the stage at LEVEL1 can be inserted before and after installation and dismantling of the stage at LEVEL2.

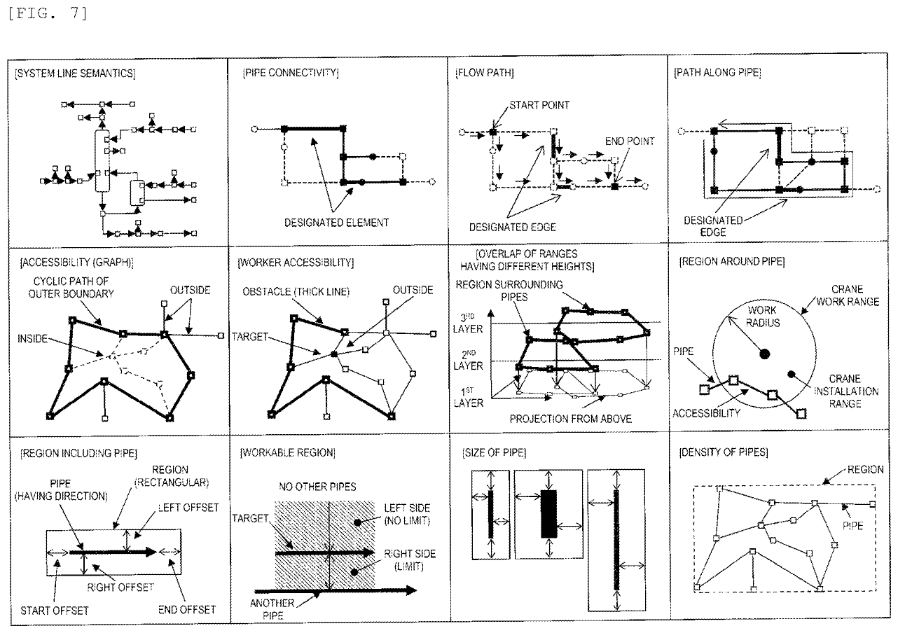

FIGS. 13A, 13B and 13C are diagrams showing an example of the master process flow information 234 according to the first embodiment.

The master process flow information 234 stores information of the master process flow including a plurality of pieces of data 1200 as shown in FIGS. 13A, 13B and 13C.

FIG. 13A is a table 1300 defining a master process flow that defines an order relationship of the processes related to the element. Specifically, a process flow for PIPE is defined in which the height level is LEVEL2 and the crane is used.

In the table 1300, a series of process flows from dismantling work to construction work, such as attaching the hanging bracket of the crane, detaching the hanging bracket of the crane after dismantling, attaching a replacement component to the crane, detaching the hanging bracket after construction, are defined.

By defining the dismantling work and construction work of each element as the master process flow, a process flow having a large scale can be generated.

FIG. 13B is a table 1310 defining a master process flow that defines an order relationship of the processes according to the height level. Specifically, a process flow of installation and removal of the crane and installation and dismantling of the stage is defined. An operator between LEVEL1 and LEVEL2 of the height level determination 1205 of a second entry from the top is a symbol representing a logical sum. That is, “LEVEL1 or LEVEL2” is shown.

When an element whose height level is LEVEL2 is included in the maintenance target, it is necessary to execute the process flow defined in FIG. 13B.

When only an element whose height level is LEVEL1 is included in the maintenance target, the process flow of LEVEL2 is unnecessary, and a process flow including a process of ERECTION STAGE LEVEL1 and a process of DISMANTLE STAGE LEVEL1 is executed. The processes of the dismantling work and construction work of the element are inserted between the process of stage erection and the process of stage dismantling.

When an element whose height level is LEVEL2 is included in the maintenance target, ERECATION_STAGE_LEVEL2 is executed, then a process flow is formed in which dismantling the element at LEVEL2, dismantling the element at LEVEL1, constructing the element at LEVEL1, constructing the element at LEVEL2, and dismantling the stage at LEVEL2 are executed.

Regarding processes in distant regions, there is no difference in the number of work steps and the work time between a case where the processes are executed continuously and a case where the processes are executed individually. Since the regions are distant, it is reasonable to work in parallel simultaneously, and to construct the stage collectively after carrying in a material, and this may be treated as a scheduling problem.

FIG. 13C is a table 1320 defining a master process flow that defines an order relationship of the processes unrelated to the element and the height level. Specifically, a process flow to be executed before a start of maintenance such as DRAIN and CARRY_IN_MATERIAL in the pipe of the system line is defined. The master process flow information 234 also includes a table defining a process flow to be executed after a completion of the maintenance.

An order of processes included in the master process flow and insertion of a flow between the master process flows are implemented as processing logic or algorithms. A field for setting the order may be provided in the data 1200 defining the process. In this case, a process flow can be generated based on a value set in the field. However, since the number of elements is the number of elements included in the maintenance range serving as an input, order setting is process setting that makes the order clear, and for example, the order cannot be set when no restriction is on the order between the elements.

The master process flow has been described as above.

Next, a work time calculation equation for calculating the work time will be described. A unit of the work time is time, but maintenance, refurbishment, and construction of the plant are managed in days because a long time is required. The calculation equation of the work time is formulated as in equation (1).

$$\begin{matrix}[ Equation 1 ] & \\ D = \frac{Q}{A \times S} & ( 1 )\end{matrix}$$

Here, D is the number of work days (day), Q is construction quantity (construction unit), A is construction capacity (construction unit, day, number of inputs) , and S is input quantity (number of inputs). The construction capacity is a construction amount per day, a productivity of execution amount per unit, and an original unit. The construction quantity is a target scale, and is expressed in units of number and size. The input quantity is the quantity of resources such as workers, and means the number of personnel and the number of groups.

It is considered that the work time includes a process unique time necessary for executing a certain process, such as a process unique setup, in addition to handling elements. Therefore, the work time is divided into target work time and process unique time.

### [Equation 2]

D=D_{target}+D_{unique} (2)

D_{target} is the target work time, and D_{unique} is the process unique time.

Although the work time is expected to be shortened as the number of inputs, that is, the number of workers increases, the work target is limited to a partial region in the maintenance work. It is not assumed that work proceeds simultaneously, in parallel and orderly in a wide work region such as a new plant or a building. In a case where a wide work region is to be maintained to change simultaneously, after the maintenance process is designed to advance the maintenance work for each target, a parallel possible range is determined, and this maybe treated as a scheduling problem.

Therefore, if the input quantity is ignored, the construction quantity is considered to be a load of the construction work per unit of construction capability.

The size and weight of the element as a construction target correspond to the load of the construction work. A moving distance corresponds to a time load of the work. When equipment is used, the load can be reduced. The ease of the work depends on a breadth of the work space, presence or absence of an obstacle, and a height. It is also a load that the required amount of additional work varies depending on the size of the target or the like.

From the above considerations, a calculation equation of the target work time can be modeled as in equation (3) as an example.

$$[ Equation 3 ]$$

$${D}_{target} = [ SIZE \times WEIGHT \times \frac{MOVING DISTANCE}{DEVICE} \times \frac{OBSTACLE HEIGHT}{BREADTH} \times ( 1 + INC1DENTAL WORK AMOUNT ) ] + A$$

A factor of the load of the construction work is related to the maintenance target and the work space, and can be evaluated in step S108. Therefore, the calculation equation of the target work time may be defined as a parametric equation as the factor of the load of the work, and a parameter value may be obtained.

The calculation equation of the target work time is equation (4).

### [Equation 4]

D_{target}=f(D₁, D₂, . . . , Dₙ) (4)

A function f is any as long as it can be implemented depending on a computer, a language or the like. In equation (5) as an example, D₁ is a weight, D₂ is a moving distance, and D₃ is a value determined by the breadth of the work space.

$$\begin{matrix}[ Equation 5 ] & \\ {D}_{t a r g e t} = 2 \times {D}_{1} \times \frac{{D}_{2}}{{D}_{3}} & ( 5 )\end{matrix}$$

The work time calculation equation has been described as above.

Definitions of calculation equations of the master process flow and the work time have been described as above.

Next, details of the pipe constraints will be described. The process planner 213 extracts the maintenance range including the essential pipe by executing the processing based on the pipe constraints.

First, the system line semantics will be described. The system line semantics is information specifying a system line (a combination of pipes and machines functioning in series). In the three-dimensional CAD, an attribute (the system line semantic information 241) representing the system line semantics is set in the P&ID connection relationship in advance. By collecting the elements based on the system line semantic information 241, the elements to be maintained can be selected.

In the P&ID shown in FIG. 9, the Pipe 1 (901) is a system line that flows from the external boundary BND (914) to the Stripper (911) via a Pump 1 and a Valve 1. The Pipe 2 (902) is one of the system lines of output from the Stripper (911), which branches into the Pipe 5 (905) and the Pipe 3 (903). When the Pipe 2 is maintained, it is necessary to stop the system line connected to the Stripper (911), the Pipe 3 (903) and the Pipe 5 (905), and to empty inside of the pipe. However, when a flow is blocked by a valve 3, it is unnecessary to stop the system line from the Stream (916). Even when the Stripper (911) is stopped, the system line of the Pipe 1 (901) does not need to be stopped if the valve 1 is cut off.

In this way, if an element that needs to be stopped during maintenance of the element is associated, the element can be selected.

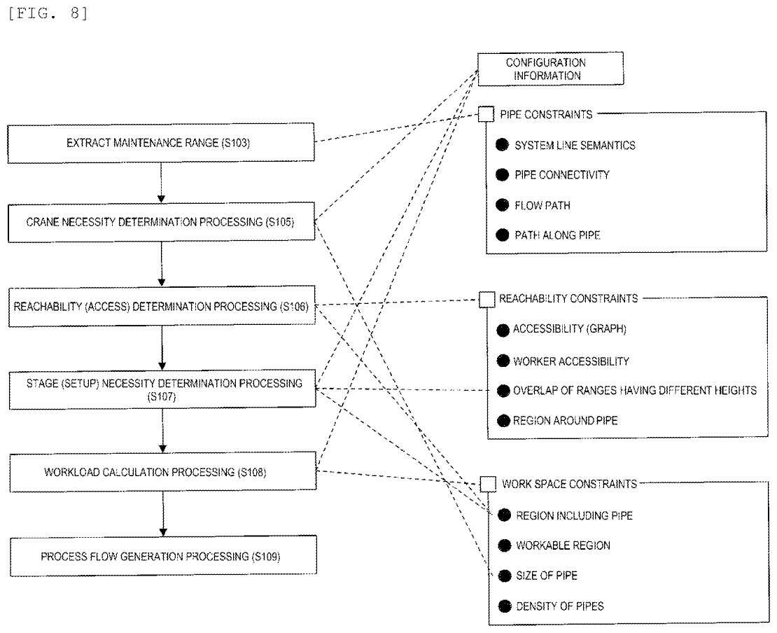

FIG. 14 is a view showing an example of a data structure of the system line semantic information 241 according to the first embodiment.

The system line semantic information 241 is data in a table format. A table 1400 is a table defining semantics of line attributes, and a table 1410 is a table defining the line attributes for each element.

In step S103, when the maintenance range is extracted based on semantics such as a system to be input to a specific reaction device, the maintenance range extraction unit 221 searches for an entry with reference to the table 1400 using the semantics as a keyword, and further searches for an element with reference to the table 1410.

It can be seen from the table 1400 that a LINE 001 is referred to as “material 1 input” and a LINE 002 is referred to as “material 2 input”. It can be seen from the table 1410 that the elements belonging to the LINE 001 are P001, P003, SRC001, VLV003 and JNT008.

When composite semantics is set for the system line, a field having the semantics necessary for the entry of the table 1400 may be provided. In the table 1410, the elements belonging to each pipe may overlap.

The system line semantics has been described as above.

Next, the constraint on the pipe connectivity will be described. The constraint is used to connect pipes including all designated pipes, that is, to acquire a graph. The constraint is to satisfy the following two conditions: (1) one or more elements are connected to the designated element, and (2) all of the selected elements are connected and the system line is single.

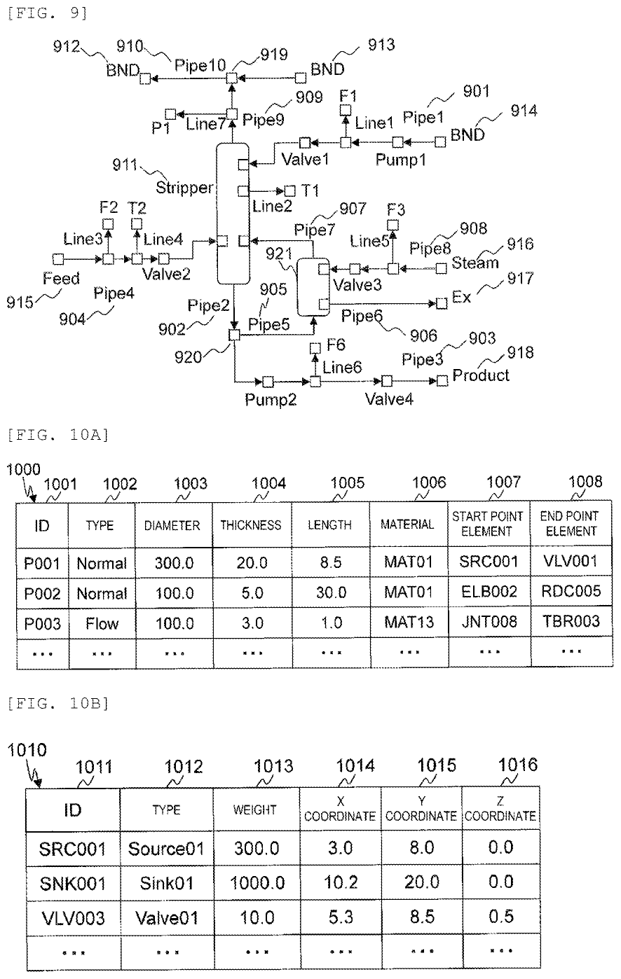

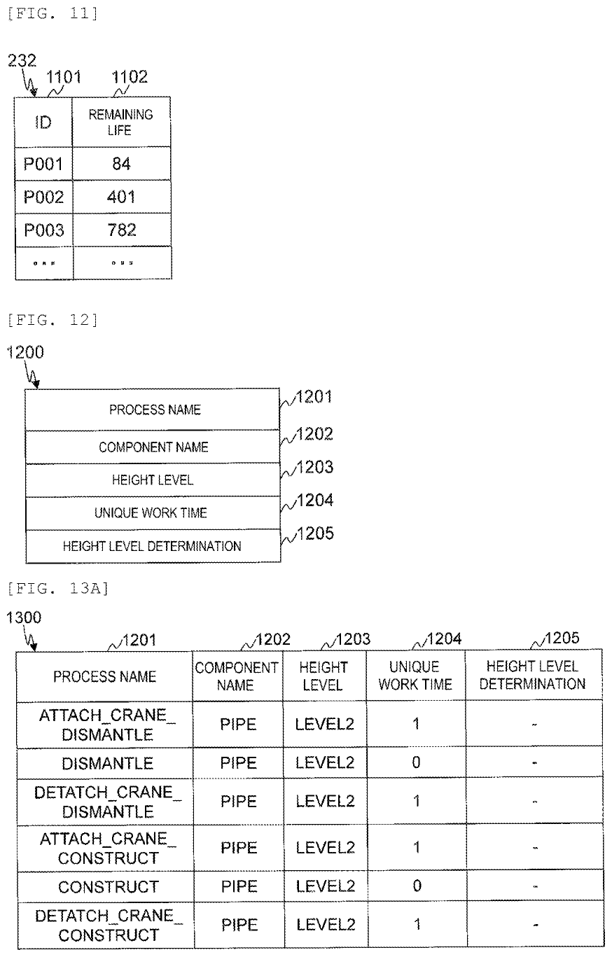

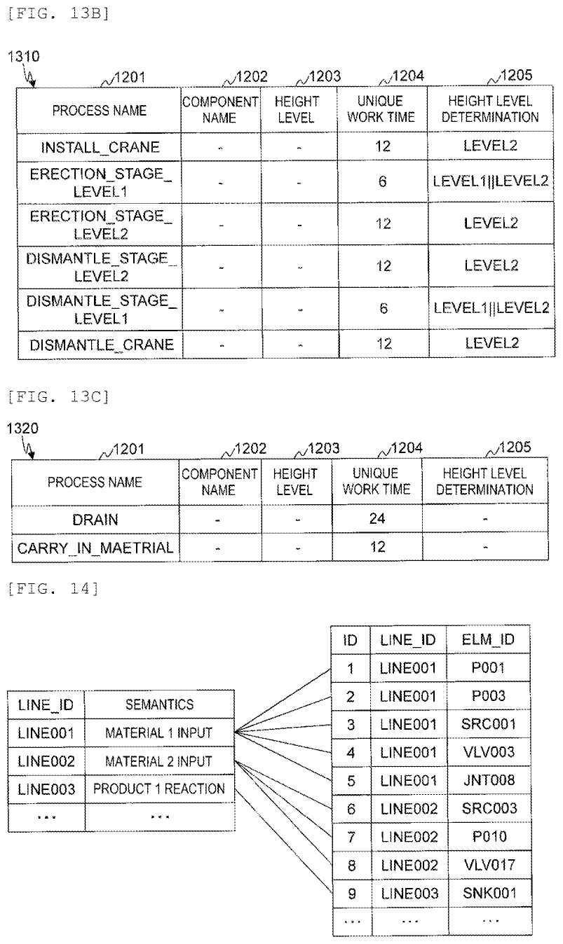

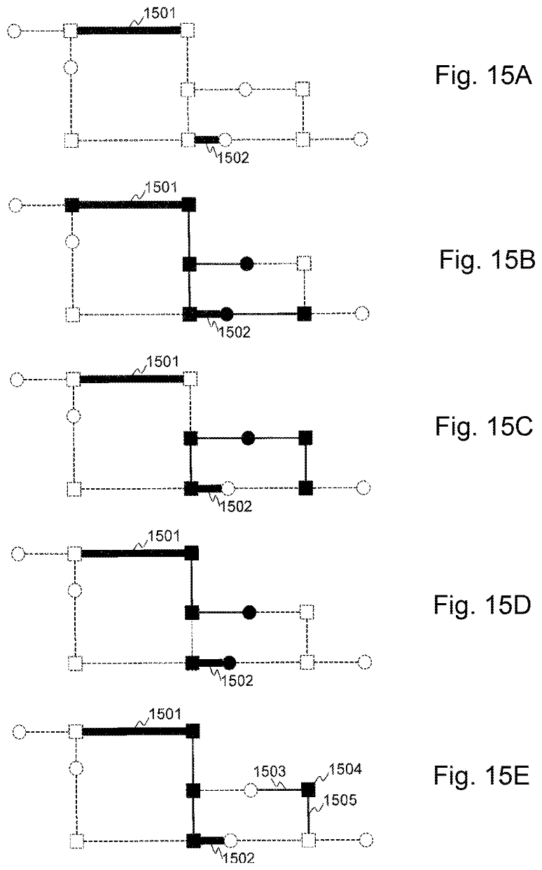

FIGS. 15(A), 15(B), 15(C), 15(D) and 15(E) are views each showing an example of connection between pipes and machines. FIGS. 15(A), 15(B), 15(C), 15(D) and 15(E) show five types of connection (A), (B), (C), (D) and (E) of plants having the same structure.

FIG. 15(A) shows a state in which an element is selected. Here, a straight line represents a pipe. The designated pipes 1501, 1502 are represented by thick solid lines. The selected pipe is represented by a thin solid line, and the non-selected pipe is represented by a dotted line. The machine is represented by a circle or a square. A white outline indicates that no selection has been made, and a black outline indicates that a selection has been made.

In the combination of the elements shown in FIG. 15(B), one or more elements are connected to the designated pipes 1501, 1502, and all the selected elements are connected, and the system line is single. Therefore, the combination of the elements shown in FIG. 15(B) satisfies the constraint on the pipe connectivity.

In the combination of the elements shown in FIG. 15(C), one or more machines are not connected to the element 1501. Therefore, the combination of the elements shown in FIG. 15(C) does not satisfy the constraint on the pipe connectivity.

In the combination of the elements shown in FIG. 15(D), one or more machines are connected to the elements 1501, 1502, and all the elements are connected, but the system line is not single. Therefore, the combination of the elements shown in FIG. 15(D) does not satisfy the constraint on the pipe connectivity.

In the combination of the elements shown in FIG. 15(E), one or more machines are connected to the elements 1501, 1502, and all the elements are connected, but the system line including of the elements 1503, 1504, 1505 is not connected to any element of the system line including the elements 1501, 1502. That is, the system line is not single. Therefore, the combination of the elements shown in FIG. 15(E) does not satisfy the constraint on the pipe connectivity.

When the constraint on the pipe connectivity is implemented as information processing, the following conditions (condition 1) and (condition 2) are satisfied.

(Condition 1) The selected element is adjacent to at least one other selected element. (Condition 2) The selected element is connected to the designated element.

Here, “adjacent” means that the elements are directly connected without any other elements.

Elements satisfying (condition 1) are obtained based on the following algorithm.

When an element i is selected, a value is set “1”, and when the element i is not selected, an element value eᵢ is set to a value “0”. The element value eᵢ is defined as in relationship (6) . The element value eᵢ of the essential pipe is set to “1”.

### [Relationship 6]

eᵢ∈{0,1} (6)

Elements adjacent to the element i can be expressed as a set as in equation (7).

$$\begin{matrix}[ Equation 7 ] & \\ {adj}_{i} = {{⋃}^{{m}_{i}}}_{j = adj ( i )} \{ j \} & ( 7 )\end{matrix}$$

mᵢ is the number of elements adjacent to the element i. A function adjᵢ is a function for acquiring an index of an element adjacent to the element i.

Here, an absolute value of a difference between element values eᵢ, eⱼ of the element i and an adjacent element j is considered. When the element j is selected, the absolute value of the difference between the element values is 0. On the other hand, when the element j is not selected, the absolute value of the difference between the element values is 1. Using this, a condition under which one or more adjacent elements are selected for a certain element i can be expressed as relationship (8). A function cdtᵢ is defined by equation (9).

$$\begin{matrix}[ Relationship 8 ] & \\ {cdt}_{i} < {m}_{i} & ( 8 ) \\ [ Equation 9 ] & \\ {cdt}_{i} = {\sum }_{j ∈ {adj}_{i}} sgn ( \vert {e}_{i} - {e}_{j} \vert ) & ( 9 )\end{matrix}$$

Here, a function sgn (d) is a function that returns “1” when d is positive, “0” when d is 0, and “−1” when d is negative.

In a case where the element i is not selected, if all other adjacent elements are selected, equation (8) is not satisfied, and it means that such an element i is not connected to all adjacent elements. In a case where the element i is a pipe, if machines at both ends are selected, it means that the pipe i is always selected. In a case where the element i is a machine, when all the pipes connected to the machine are selected, it means that the machine is always selected. Therefore, relationship (8) is used as (condition 1).

Selection of elements based on (condition 1) may solve the constraint satisfaction problem using an integer constraint programming technology or a mixed integer programming (MIP) technology.

(Condition 2) is the following algorithm.

The element value eᵢ is given to an element satisfying (condition 1). The element value eᵢ of the essential pipe is 1. Therefore, for the element i whose element value eᵢ is 1, whether one element adjacent to the essential pipe is connected to another element may be confirmed.

Specifically, confirmation is executed using equation (7). That is, the selected elements are listed among the elements adjacent to one element adjacent to the essential pipe by using an adjacency relationship of equation (7). Among the elements adjacent to the listed elements, the selected elements are listed. When the above-described processing is repeated, the listed elements become constant. If another selected element is included in the listed elements, that element is not connected.

The constraint on the pipe connectivity has been described as above.

Next, the constraint on the flow path will be described. The flow path is a path from the designated start point to the designated end point through the designated pipe. The constraint on the flow path is used to specify a pipe that is likely to deteriorate due to a high pressure or a high flow rate.

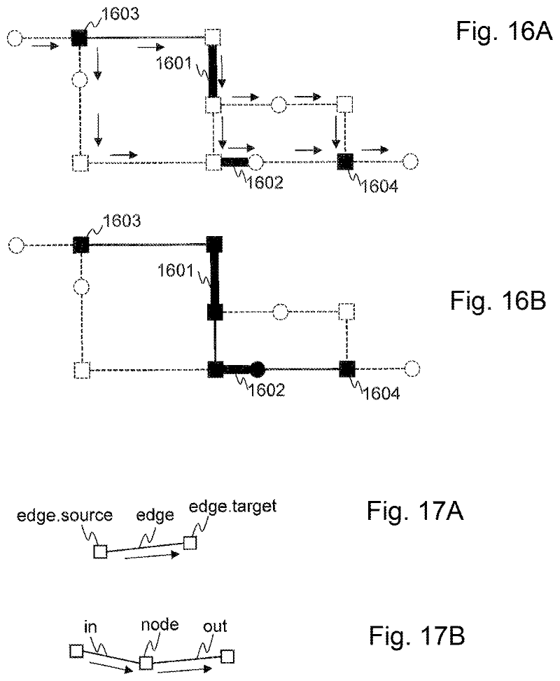

FIGS. 16(A) and 16(B) are views showing a method of specifying the flow path according to the first embodiment.

Rules for displaying the elements in FIGS. 16(A) and 16(B) are the same as those described with reference to FIGS. 15(A), 15(B), 15(C), 15(D) and 15(E). Here, a pipe is referred to as an edge, and a machine is referred to as a node. A start point and an end point are set in the edge, and the node is the start point or the end point of the edge. In FIG. 16(A), an arrow from the start point to the end point is attached to each edge.

FIG. 16(A) shows a state in which edges 1601, 1602 are designated, a start point 1603 is designated as a start point of a flow path, and an end point 1604 is designated as an end point of the flow path. FIG. 16(B) shows a flow path. A path of a flow passing through the edges 1601, 1602 is only the path shown in FIG. 16(B). When only one of the edge 1601 and the edge 1602 is designated, two flow paths are obtained.

The constraint on the flow path is to satisfy that an edge whose start point designated as a start point, the designated edge, and an edge line whose end point designated as an end point are connected to one line.

A method for implementing the constraint on the flow path as information processing will be described.

First, a relationship between the edge and the node is defined for handling in the information processing. FIGS. 17(A) and 17(B) are views showing the relationship between the edge and the node. FIG. 17(A) shows a relationship between a start point and an endpoint for one edge, and FIG. 17(B) shows a relationship between one node and an end point and a start point of edges.

The start point set on the edge is represented as source since it is an inflow point of the pipe, and the end point set on the edge is represented as target since it is an outflow point of the pipe. The pipe on an inflow side of the node, that is, the pipe whose end point is the node is represented by in, and the pipe whose start point is the node is represented by out.

When an edge i is selected, a value “1” is set, and when the edge i is not selected, a value edgeᵢ is set to a value “0”. The value edgeᵢ is defined as in relationship (10).

### [Relationship 10]

edgeⱼ∈{0,1} (10)

A target path (a combination of elements) is connection of a series of pipes from the start point to the end point. In this connection, branching and coupling cannot be executed at the node.

The number of edges j whose end point is a node i is set as nⁱⁿᵢ, and the number of edges j whose start point is the node i is set as n^{out}ᵢ. Here, inᵢⱼ and outᵢⱼ are values of the edge j adjacent to the node i, and are defined as equations (11) and (12).

### [Equation 11]

inᵢⱼ=edgeᵢ|edgeⱼ·target==nodeᵢ (11)

### [Equation 12]

outᵢⱼ=edgeⱼ|edgeⱼ·source==nodeᵢ (12)

A sum is taken with the inflow side being negative and the outflow side being positive, and the number of input and output is obtained by using equation (13).

$$\begin{matrix}[ Equation 13 ] & \\ {in\_out}_{i} = - {\sum }_{j}^{{n}_{i}^{i n}} i {n}_{i j} + {\sum }_{j}^{{n}_{i}^{o u t}} o u {t}_{i j} & ( 13 )\end{matrix}$$

As shown in equations (14), (15) and (16), the number of input and output should be 0 at the node intermediate in the path, and a start point st should be 1 and an end point en should be −1.

### [Equation 14]

in_outₛₜ=1 (14)

### [Equation 15]

in_outₑₙ=−1 (15)

### [Equation 16]

in_out_{i|i≠st,en}=0 (16)

A plurality of inflow pipes and a plurality of outflow pipes are not adjacent to each other in the machine. If the actual connection of the machines and pipes is modeled such that the plurality of inflow pipes are adjacent to one machine, machines considered different from that machine are connected with one pipe, and the plurality of outflow pipes are adjacent to the connected machine, connection satisfying the above constraints is obtained.

As a result, an edge whose value is 1 is the selected pipe, and a node serving as a start point or an end point of the edge is the selected machine.

Selection of elements based on the constraints may solve the constraint satisfaction problem using the integer constraint programming technology or the MIP technology.

The constraint on the flow path has been described as above.

Next, the constraint on the path along the pipe will be described. The path along the pipe is a path that circulates from the designated start point to the start point again through the designated pipe. In the maintenance work, when a position at the end of the work is the same as a start position, maintenance efficiency may be improved from a viewpoint of transportation means such as a car. The constraint on the path along the pipe is used to identify such a path.

Even if the start point and the end point are designated separately, the constraint on the path along the present pipe can be implemented as information processing by providing the same termination condition as the constraint on the flow path.

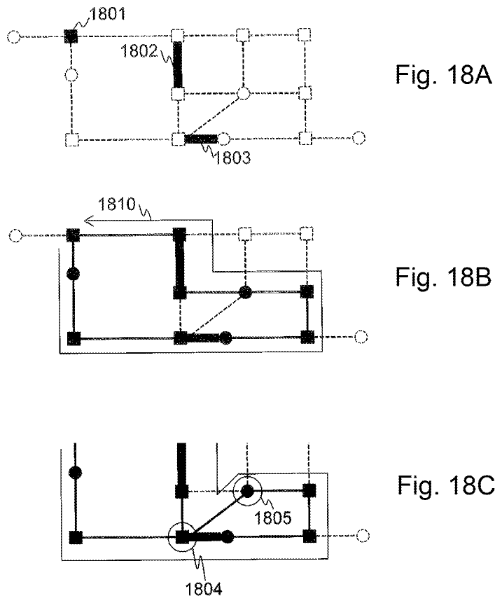

FIGS. 18(A), 18(B) and 18(C) are views showing a method of specifying the path along the pipe according to the first embodiment.

Rules for displaying the elements is the same as those described with reference to FIGS. 15(A), (B), (C), (D) and (E). FIG. 18 (A) shows a state in which a start point 1801 and two pipes 1802, 1803 are designated. Although a start point and an end point corresponding to a flow direction are set as an edge of the pipe, circulation of the path along the pipe is not considered.

FIGS. 18(B) and 18(C) are each an example of the path along the pipe. As a cyclic path including the start point 1801 and the pipes 1802, 1803, a cyclic path such as paths 1810, 1811 can be provided.

The path 1811 is different from the path 1810 in that the path passes through a node 1804 again, then passes through the node 1804 again from a node 1805, and proceeds from there to the start point 1801. In this way, if a so-called one-stroke writing is established, a cyclic path is formed.

The value edgeᵢ of the edge i in the cyclic path is defined by relationship (10). The relationship between the edge and the node is as shown in FIGS. 17(A) and 17(B).

In the cyclic path, when a flow enters a node through one edge, the flow goes out though the other edge. The value of the edge j serving as the start point or the end point with respect to the node i is defined as in_outᵢⱼ and is defined as in equation (17).

$$\begin{matrix}[ Equation 17 ] & \\ {in\_out}_{ij} = {edg}_{j} \vert \begin{matrix}{edge}_{j} \cdot target == {node}_{i} \\ {edge}_{j} \cdot source == {node}_{i}\end{matrix} & ( 17 )\end{matrix}$$

At the node i, a sum of the number of incoming edges and outgoing edges is calculated from equation (18). n^{in_out}i represents the number of edges connected to the node i.

$$\begin{matrix}[ Equation 18 ] & \\ {con}_{i} = {\sum }_{j}^{{n}_{i}^{in\_out}} {in\_out}_{ij} & ( 18 )\end{matrix}$$

A sum of input and output is 0. However, as shown in FIG. 18(C), the same node maybe passed many times. Therefore, as shown in equation (19) , the constraint is obtained by taking a remainder of 2.

### [Equation 19]

conᵢ≡0 (mod. 2) (19)

As a result, an edge whose value is 1 is the selected pipe, and a node serving as a start point or an end point of the edge is the selected machine.

Selection of elements based on the constraints may solve the constraint satisfaction problem using the integer constraint programming technology or the MIP technology.

The processing based on the constraint on the path along the pipe has been described as above.

A method of extracting the maintenance range based on the pipe constraints has been described as above.

Next, details of the reachability constraints will be described. The process planner 213 specifies a process required for the selected maintenance range by executing processing based on the reachability constraints, and collects elements and regions handled in the process.

The reachability constraints are used in reachability determination processing and the stage necessity determination processing. Specifically, in the reachability determination processing, all the reachability constraints are used, and in the stage necessity determination processing, the constraint on the overlap of height ranges is used.

First, the constraint on the accessibility (graph) will be described. When the maintenance range is a graph including edges and nodes, the constraint is used to list elements inside the cyclic path that is the outer periphery of the graph.

When the pipes and machines are installed on a ground surface and there is no gap entering inside of the outer periphery and the outer periphery cannot be got over, it means that the inside cannot be entered unless an element of the outer periphery is dismantled. In an actual plant, since the pipes and machines are arranged three-dimensionally, processing for disassembling the element on the outer periphery is unnecessary.

The constraint is used to separate inside and outside of a graphical and spatial configuration such as when determining a range where the crane can be installed, and when obtaining an inside element in a partial cyclic path to evaluate complexity of the element.

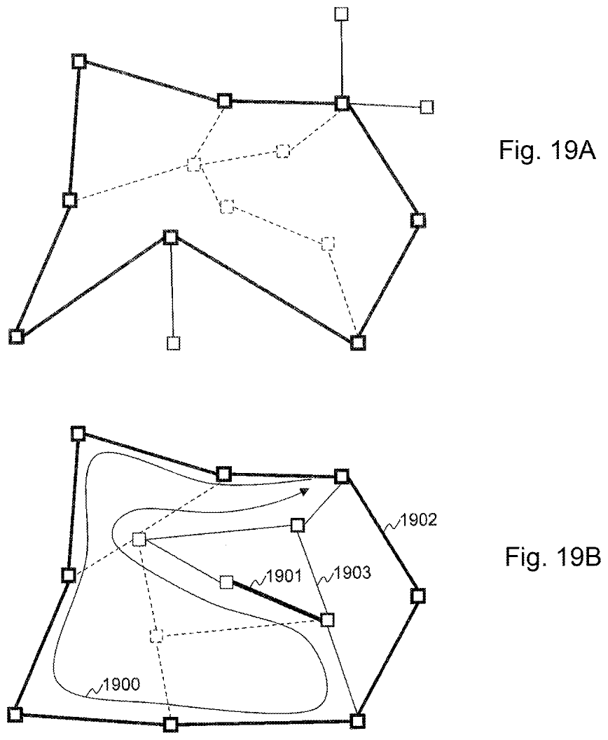

FIGS. 19(A) and 19(B) are views showing a state of elements on the outer periphery forming the cyclic path.

FIG. 19 (A) shows an example of the outer periphery. A thick solid line indicates the element on the outer periphery, a broken line indicates the element inside the outer periphery, and a solid line indicates the element outside the outer periphery. FIG. 19(B) shows an outer periphery including a pipe 1901 at a maintenance target inside. Here, it is assumed that the pipe 1901 cannot be reached unless an element included in the outer periphery is dismantled. In this case, if an element 1902 is dismantled and then an element 1903 is disassembled, the outer periphery including the element 1901 becomes a cyclic path 1900, so that the element 1901 can be reached. That is, it can be seen that dismantling of elements 1902, 1903 is a process required for maintenance work of the element 1901. When a worker moves to the element 1901 for inspection, it can be seen that a process of installing a stage or a stair at elements 1902, 1903 is required.

In the present embodiment, in order to obtain the cyclic path for determining the outer periphery, the constraint on the path along the pipe is used.

First, the process planner 213 specifies all cyclic paths using the graph obtained from the maintenance range. The process planner 213 has a cyclic path having a maximum area as the outer periphery. When all elements are arranged on the ground surface, the process planner 213 may evaluate a maximum value of the area. However, when the elements are arranged three-dimensionally, if a vertical projection on the ground surface is taken, a plurality of cyclic paths may not fall within regions of each other. In such a case, the outer periphery may be determined from a union of regions.

The outer periphery is a polygon in which any vertices are arranged. When this area is calculated, the outer periphery may be divided into two single units (triangles) according to the following processing.

(S1) The process planner 213 forms directional edges in an order with the vertices of the outer periphery counterclockwise.

(S2) The process planner 213 sets two single units if three connected vertices form a triangle counterclockwise.

(S3) The process planner 213 removes the two single units from the cyclic path, and adds edges after removal.

(S4) If the cyclic path forms a triangle, the process planner 213 sets the triangle as two single units. The process planner 213 obtains a sum of areas of the two obtained single units, and ends the processing.

(S5) The process planner 213 returns to (S2).

The inside and outside determination of the element with respect to the cyclic path can be solved as the inside and outside determination of the vertices with respect to all the two units.

The constraint on the accessibility (graph) has been described as above.

Next, the constraint on the worker accessibility will be described. The constraint is used to specify a cyclic path of an element that the worker cannot reach and an installation location of a stage. When there is an element as a maintenance target inside the cyclic path of the element, it is necessary to install the stage or the like in order to access the element. When the element is installed at a high place, it is necessary to install the stage.

When an element as a maintenance target is on the ground surface and there is no pipe or the like as an obstacle, no problem occurs in accessing the element. Here, a pipe as an obstacle refers to a large pipe (for example, a pipe whose diameter is 1 m or more) on the ground surface.

The process planner 213 forms a graph only from the pipe as the obstacle and a machine adjacent to the pipe, and evaluates accessibility of the pipe as the maintenance target based on the constraint on the accessibility (graph). When the pipe as the maintenance target exists inside the outer periphery formed by the pipe as the obstacle, the process planner 213 determines that installation of the stage for exceeding the pipe as the obstacle is necessary as a process.

Regarding the installation of the stage, as described in the constraint on the accessibility (graph), the pipe forming the outer periphery may be removed so that the pipe as the maintenance target forms the outer periphery. The pipe to be removed is the installation location of the stage.

When the pipe as the maintenance target is at the high place, the stage is required. Necessity of the installation of the stage depends on a height of the installation location of the pipe as the maintenance target. The height of the installation location of the pipe is discretely defined as a height range as shown in FIG. 20 in order to correspond to the number of stages of the stage. As shown in FIG. 20, in the first embodiment, the height range is set as LEVEL. Each LEVEL is set for a range equal to or larger than a lower limit and smaller than an upper limit. For example, 0 m or larger and smaller than 1 m is set as LVL01, 1 m or larger and smaller than 3 m is set as LVL02, and 10 m or larger is set as LVL04. When the stage can be installed, the element as the maintenance target is accessible to the worker.

Sharing of the stage is processed using the constraint on the overlap of the height ranges.

The constraint on the worker accessibility has been described as above.

Next, the constraint on the overlap of ranges having different heights will be described. The constraint is used to determine whether it is necessary to install a sharable stage. When elements as maintenance targets are in a state of being adjacent or close to each other, the stage can be shared. Even if heights of installation locations of the elements are different, the stage can be shared by an upper layer and a lower layer when stage regions overlap in a plane, that is, in a range of only X and Y coordinates.

In order to determine whether adjacent pipes and stages can be shared, adjacency of one pipe is evaluated. When pipes installed at the same height level are adjacent, it is determined that the stage can be shared. Evaluating that pipes are close to each other corresponds to evaluating an overlap of work regions. That is, it is equivalent to determining whether work can be executed simultaneously.

Therefore, the constraint on the region including the pipe included in the constraints on the work space is used. In processing based on the constraint on the region including the pipe, the process planner 213 generates a region including one pipe, and executes evaluation based on presence or absence of other elements in the region or an overlap with a region of another pipe. Details of the processing will be described below. When the pipe is expressed by a line segment, the region including the pipe can be represented as a rectangle surrounding the line segment with offset.

When the stage can be shared, the worker may sequentially dismantle and construct a plurality of pipes after erecting the stage in advance, and dismantle the stage collectively after installation is completed.

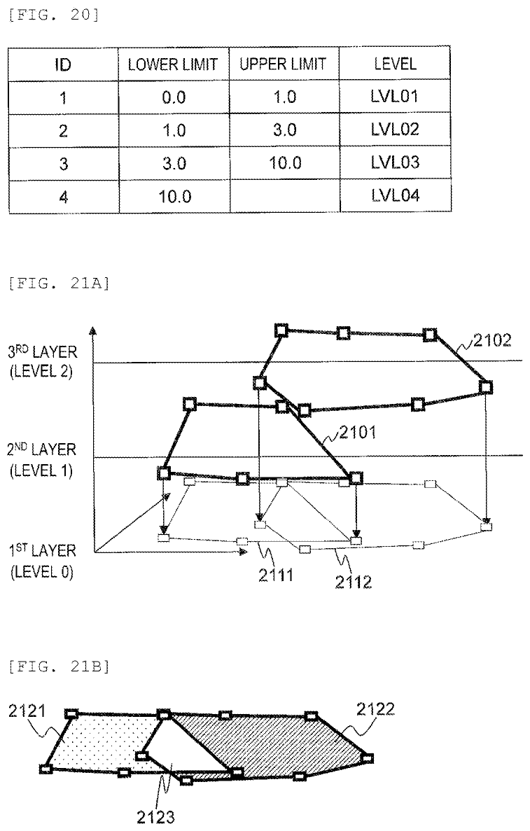

FIGS. 21A and 21B show an example of a state in which regions of pipes having different height levels overlap in a plane.

FIG. 21A shows regions 2101, 2102 surrounded by pipes having different height levels. A region 2101 is a region surrounded by pipes installed in a second layer, and a region 2102 is a region surrounded by pipes installed in a third layer. Regions surrounded by the pipes maybe interpreted as the region including the pipe, and this region is defined as a work space for executing maintenance work.

Projections of the regions 2101, 2102 from vertically above are regions 2111, 2112. As shown in FIG. 21A, the regions 2111, 2112 overlap have an overlapping portion. The region 2111 and the region 2112 can be divided into three regions 2121, 2122, 2123 as shown in FIG. 21B.

The region 2121 is a region excluding the overlapping portion of the region 2111 and the region 2121 from the region 2111, and the region 2122 is a region excluding the overlapping portion of the region 2111 and the region 2121 from the region 2112. The region 2123 is an overlapping portion of the region 2111 and the region 2121.

When a stage in the upper layer is installed, since the stage is also installed in a region of the same x, y coordinates, a stage is installed in the second layer at a time in a region obtained by adding the region 2121, the region 2122 and the region 2123. In the third layer, a stage may be installed only in the region 2112. In general, an entire region Aₖ of the stage in a k-th layer is expressed as equation (20) when there is a work region up to an m-th layer above the k-th layer.

$$\begin{matrix}[ Equation 20 ] & \\ {A}^{k} = {{⋃}_{{i}_{k} = 1}}^{{n}_{k}} {A}_{{i}_{k}}^{k} {{⋃}_{{i}_{k + 1} = 1}}^{{n}_{k + 1}} {A}_{{i}_{k + 1}}^{k + 1} … {{⋃}_{{i}_{m} = 1}}^{{n}_{m}} {A}_{{i}_{m}}^{m} & ( 20 )\end{matrix}$$

Here, Aⱼᵢ is the i-th partial region in a j-th layer. The total number of partial regions in the j-th layer is n₁.

The constraint on the overlap of the height ranges has been described as above.

Next, the constraint on the region around the pipe will be described. The constraint is used to determine whether the crane can be arranged in the area around the pipe, particularly in an area outside the cyclic path serving as the outer periphery of the pipe, or to determine a work radius at which the hanging bracket can access the pipe.

FIG. 22 is a view showing an example of a positional relationship between the crane and the pipe. The crane is arranged at a point 2201. A work radius 2202 is a distance at which the hanging bracket of the crane can reach. A work region 2203 is represented as a circle having a point 2201 as a center and the work radius 2202 as a radius. Among pipes 2211, 2212, 2213, only the pipe 2212 is included in the work region 2203. Therefore, the process planner 213 determines that work of the crane on the pipe 2212 is possible. In order to execute the work of the crane on the pipes 2211, 2213, it is necessary to change arrangement of the crane or to increase the work radius.

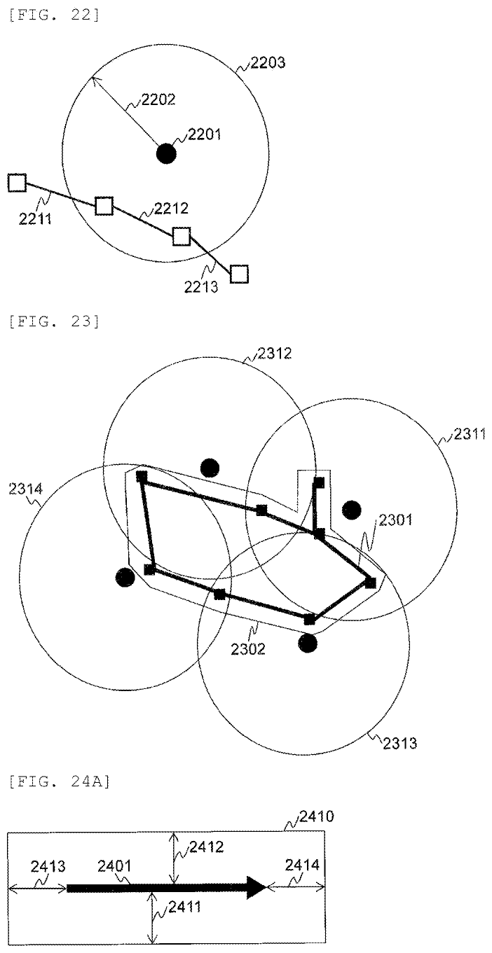

FIG. 23 is a view showing an example of the arrangement of the crane with respect to a maintenance range.

The maintenance range in FIG. 23 is set as an outer periphery 2301 of pipes. The outer periphery 2301 includes a pipe outside the outer periphery. A region required for maintenance work is set as an offset region 2302. The crane can only be arranged outside the offset region 2302.

The process planner 213 searches for an arrangement location of the crane and specifies a work region 2311 such that as many pipes as possible are included in the working area of the predetermined work radius. The process planner 213 specifies work regions 2312, 2313, 2314 by executing the same processing.

Alternatively, the process planner 213 specifies the arrangement location of the crane and determines the work region to include all elements. In this case, the process planner 213 may execute adjustment for reducing a variation in the work radius between cranes. For example, the process planner 213 optimizes a combination of specifications of the cranes for a purpose of minimizing operational cost of the cranes.

The constraint on the region around the pipe has been described as above.

The reachability constraints have been described as above.

Next, details of the work space constraints will be described. The process planner 213 calculates the work time for evaluating the workability of the process by executing processing based on the work space constraints.

First, the constraint on the region including the pipe will be described. The constraint is used to evaluate an area of the region including the pipe included in the maintenance range and presence or absence of the pipe in the region. The constraint is passed to evaluate the area of the region and evaluate the workability. For example, it is determined that the work time is increased as the region is enlarged, while the workability is improved.

FIGS. 24A and 24B are views showing an example of the region including the pipe.

An arrow 2401 represent a pipe. A direction of the arrow indicates a direction of a flow. The process planner 213 takes a right offset 2411 on a right side, a left offset 2412 on a left side, a start offset 2413 on a start point side, and an end offset 2414 on an end point side with respect to the arrow direction, and forms a region (a rectangle) 2410. An amount of the offset is defined in advance as a space required for the work.

Offset lines of the region 2410 are treated as edges forming a counterclockwise rectangle. Thereby, the process planner 213 generates vertices at points where the edges overlap with respect to overlaps of the plurality of offsets, such as when pipes are connected, and divides the edges at the vertices. Then, the process planner 213 can generate an offset region in which a plurality of pipes are connected, such as the offset region 2302 in FIG. 23, by obtaining connection of the edges serving as the outer periphery counterclockwise.

The offset region of the pipes is used to evaluate the workability based on the area of the region. The offset region of the pipes is also used to obtain the density of the pipes based on the presence or absence of other pipes in the offset region or the number of pipes in the offset region, and to evaluate the ease of the work.

As shown in FIG. 24B, when pipes 2431, 2432, 2433, 2434 are included in the offset region 2410, the process planner 213 can obtain the number of pipes included in the offset region 2410 based on the number of intersections between boundaries of the offset region 2410 and the pipes.

Determination of whether other pipes are included in the offset region 2410 can also be obtained by interference calculation based on the three-dimensional CAD. In this case, information on elements related to the work region may be included in the configuration information 231 in advance.

The constraint on the region including the pipe has been described as above.

Next, the constraint on the workable region will be described. The constraint is used to evaluate a distance from one pipe to another pipe. When the distance from one pipe to another pipe is short or an area of a region up to another pipe is small, it is determined that the workability is low.

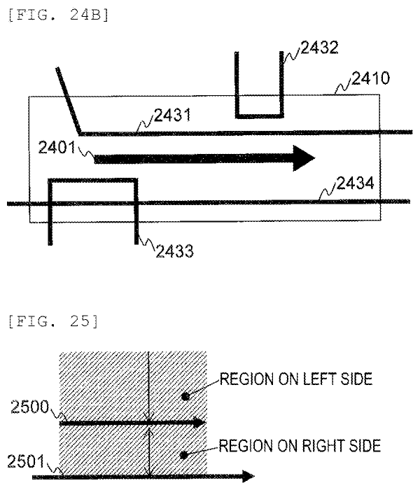

FIG. 25 is a views showing a concept of a method for evaluating the workable region. The workable region is evaluated by the presence or absence of another pipe with respect to a region having a predetermined size on a right side and a left side of a target pipe. As shown in FIG. 25, the process planner 213 forms a region having left and right offsets in a vertical direction of a pipe 2500. The process planner 213 determines that the region has a limit when another pipe exists in the region, and determines that the region has no limit when another pipe does not exist in the region. In FIG. 25, since another pipe 2501 exists in the region on the right side of the pipe 2500, it is determined that the region has a limit.

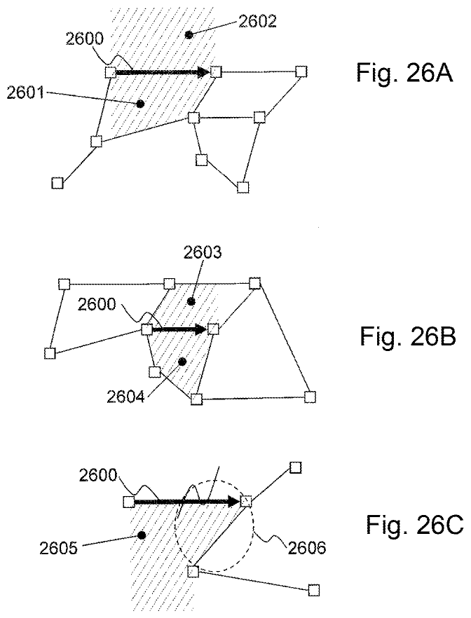

FIGS. 26(A), 26(B) and 26(C) are views showing an example of the workable region.

In FIG. 26(A), it is determined that a region 2602 on a left side of a pipe 2600 is not limited, and that a region 2601 on a right side is limited. In this case, the workability can be ensured by executing work on the pipe 2600 from the left side.

In FIG. 26(B), it is determined that both a region 2603 on the right side and a region 2604 on the left side of the pipe 2600 are limited. In this case, it is desirable to work in a wide region.

In FIG. 26(C), another pipe exists in a portion 2606 of a region 2605 on the right side of the pipe 2600. In such a region, it is necessary to evaluate the workability in a limited portion. In this case, the process planner 213 may evaluate the workability based on an area of the region on the left side and an area of the region on the right side in the limited portion 2606, or a distance to another pipe at the predetermined position to an end point of the pipe.

Processing based on the constraint on the workable region has been described as above.

Next, processing based on the constraint on the size of the pipe will be described. The constraint is used to determine an offset amount corresponding to the diameter, the length and the thickness of the pipe. The region including the pipe is set based on an offset of the pipe. The offset amount is defined in advance as a space required for the work. It is considered that the required space may vary depending on the size of the pipe. For example, when the pipe is large, the work space needs to be widened by a large amount, but a minimum required space is required for a person to work even if the diameter of the pipe is small. When the weight is large, it is necessary to set the work space according to the hanging bracket or a method for lifting.

A definition of the offset amount according to the diameter, length and weight of the pipe is set as the constraint on the size of the pipe. For example, a diameter range is classified as φ10 cm, φ20 cm, φ30 cm, φ50 cm, and values of the right offset, the left offset, the start offset and the end offset are defined as the constraint the size of the pipe according to a length range and a weight range.

The constraint on the size of the pipe has been described.

Next, the constraint on the density of the pipe will be described. When the work region (the maintenance range) is determined at a time, the constraint is used to correct evaluation on the ease of the work based on the number of pipes within the region.

The evaluation of the workability due to entry of another pipe into the work region has been described in the constraint on the region including the pipe. The evaluation of the workability when a plurality of pipes close to a certain pipe are collectively maintained, needs to be executed based on the number of pipes to be maintained in a sum of regions where the plurality of pipes are maintained.

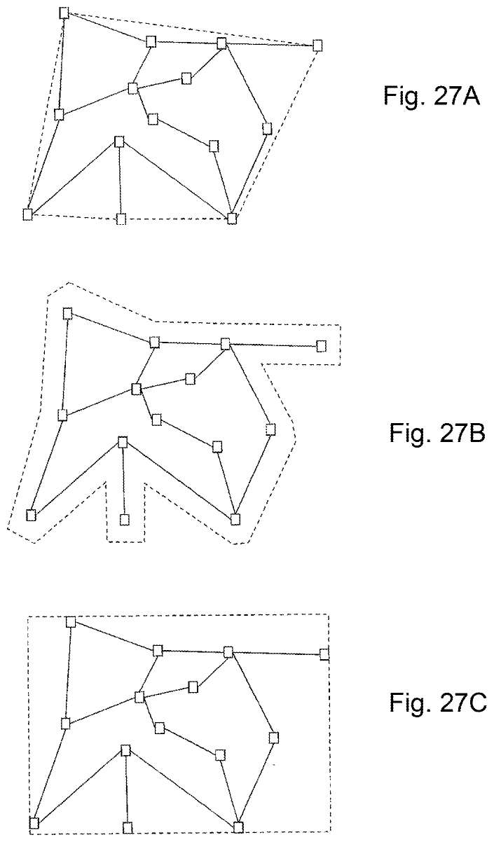

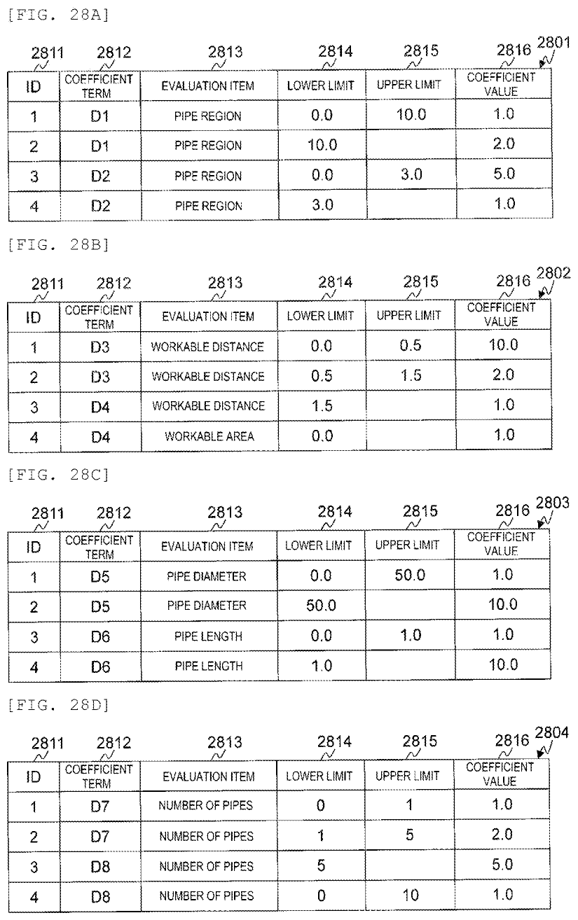

FIGS. 27(A), 27(B) and 27(C) are views showing an example of how to determine the region including the pipe.

FIG. 27 shows different regions set for pipes having the same arrangement. A region in FIG. 27(A) is a protruding region surrounding all pipes, a region in FIG. 27 (B) is a region including a sum of offsets of the pipes, and a region in FIG. 27(C) is a rectangular region surrounding all the pipes.

Which range should be taken depends on the length of the pipe. When the size and length of the pipe in a region are small with respect to the work region, the evaluation using the region in FIG. 27 (A) or 27(C) is better. In particular, when the worker does not move much, the evaluation using the rectangular region shown in FIG. 27(C) is sufficient.

An area is determined according to the region. Therefore, the process planner 213 can evaluate the ease of the work based on the number of pipes with respect to the area.

The constraint on the density of the pipes.

The work time of the process is obtained by a work calculation equation that is equation (4). A target work time calculation equation is defined as a parametric equation, and the process planner 213 calculates the parameter values in S108. That is, the work time is determined using the work space constraints. Therefore, the constraint for evaluating the workability is associated with the parameter values.

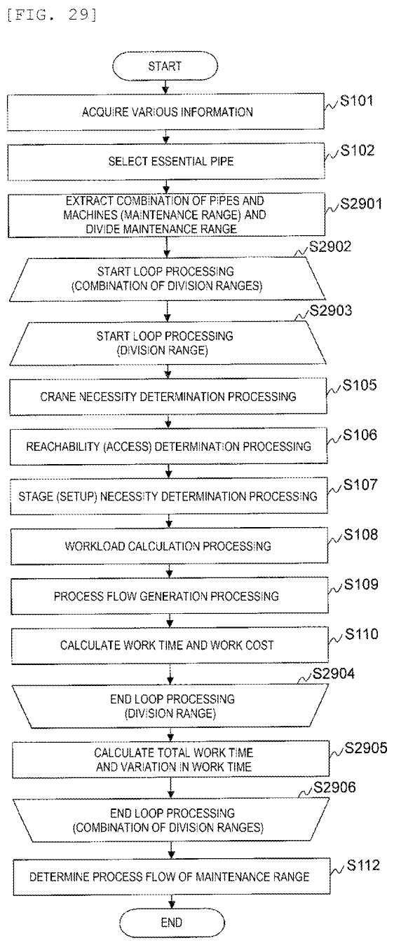

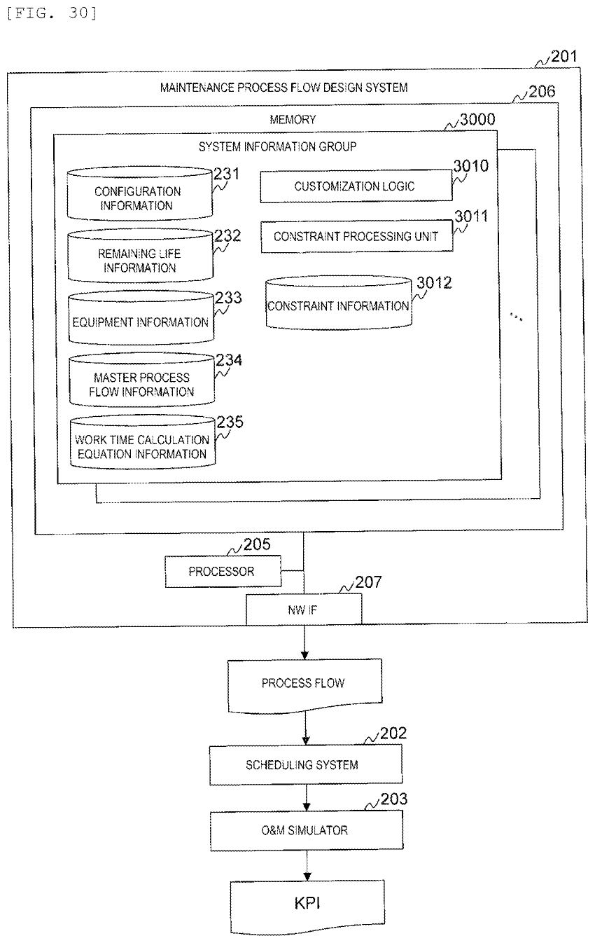

FIGS. 28A, 28B, 28C and 28D show a configuration of data for managing the work space constraints.

Tables 2801, 2802, 2803, 2084 shown in FIGS. 28A, 28B, 28C and 28D have the same data structure, and store entries each including an ID 2811, a coefficient term 2812, an evaluation item 2813, a lower limit 2814, an upper limit 2815 and a coefficient 2816.

The ID 2811 is a field for storing identification information of an entry. The coefficient term 2812 is a field for storing information on the parameters. The evaluation item 2813 is a field for storing information on an evaluation item defined in according to a type of the constraint. The lower limit 2814 and the upper limit 2815 are fields for storing a lower limit value and an upper limit value of the evaluation item. The coefficient 2816 is a field for storing a value set in the coefficient term.

For example, when a pipe region is 0.0 or larger and smaller than 10.0, an entry in which the ID 2811 of 2801 indicates that a value of a coefficient term D1 is 1.0.

The table 2801 is a table defining parameter values used in the processing based on the constraint on the region including the pipe. The table 2802 is a table defining parameters used in the processing based on the constraint on the workable region. The table 2803 is a table defining parameters used in the processing based on the constraint on the size of the pipe. The table 2804 is a table defining parameters used in the processing based on the constraint on the density of the pipes.

A relationship between the work space constraints and the parameters of the work time calculation equation has been described as above.

The work space constraints have been described as above.

The maintenance process flow design system 201 described in the first embodiment can determine the priority of the maintenance based on the remaining life of the pipe, and can determine the combination of the machines and pipes to be collectively maintained, that is, the maintenance range, based on the pipe constraints. The maintenance process flow design system 201 can utilize the information of the three-dimensional CAD to determine the necessity of setup of the crane and the stage based on the reachability constraints, and can further generate the process flow by evaluating the workability of each process based on the work space constraints.

The maintenance process flow design system 201 can calculate the work time in each process using the work time calculation equation defined by parameterizing the construction capability and the parameter values calculated based on the work space constraints.

As described above, the maintenance process flow design system 201 can design the maintenance process flow including the work time for each of the plurality of maintenance ranges. Thereby, the maintenance schedule and the cost of the maintenance range can be evaluated. This means that the inspection and collection of the maintenance targets are evaluated such that the load of the maintenance work satisfies the number of steps and the schedule.

The risk of malfunction and breakdown is small, the cost is low, the work efficiency is high, or the collection of the maintenance targets on which the maintenance work can be executed and the maintenance schedule can be planned.

### Second Embodiment

In the first embodiment, a process flow is generated for each maintenance range. In a second embodiment, a process flow for executing maintenance in maintenance ranges divided for each maintenance execution period is generated. More specifically, one process flow is generated for a plurality of maintenance ranges where elements do not overlap.

The maintenance process flow design system 201 presents a variation in work time of a combination of processes for each work execution period as information serving as a criterion for determining the quality of the process flow. For example, when the work time of each work execution period is equalized and the variation in work time is reduced, maintenance cost is leveled. On the other hand, when maintenance on many elements is executed at high cost for maintenance in any work execution period, and maintenance costs are reduced to a level of ordinary mechanical repairs in other work execution periods, the variation in the working time becomes large. The maintenance process flow design system 201 presents a standard deviation as a measure for making the determination as described above.

A configuration of a computer system according to the second embodiment is the same as that according to the first embodiment. In the second embodiment, processing executed by the computer system is partially different. FIG. 29 is a flowchart showing an example of design processing of the maintenance process flow executed by the computer system according to the second embodiment.

After processing of steps S101 and S102 are executed, the maintenance process flow design system 201 extracts a combination of pipes and machines (a maintenance range) as maintenance targets and divides the maintenance range (step S2901). A method of extracting the maintenance range is the same as that in the first embodiment.

Specifically, the maintenance process flow design system 201 divides the maintenance range by the number of maintenance execution periods. A combination of divided pipes and elements is referred to as a division range. The maintenance process flow design system 201 divides the maintenance range such that the elements included in each division range do not overlap. A plurality of combinations of division ranges is generated.

Next, the maintenance process flow design system 201 selects a combination of target division ranges (step S2902). Next, the maintenance process flow design system 201 selects a target division range from the selected combination of division ranges (step S2903).

The maintenance process flow design system 201 executes processing of steps S105 to S110 on the target division range.

After processing of step S110 is executed, the maintenance process flow design system 201 determines whether the processing has been executed for all the division ranges included in the combination of the division ranges (step S2904).

When it is determined that the processing has not been executed for all the division ranges included in the combination of the division ranges, the maintenance process flow design system 201 returns to step S2903 and executes the same processing.

When it is determined that the processing has been executed for all the division ranges included in the combination of the division ranges, the maintenance process flow design system 201 calculates a total value of the work time of the combination of the division ranges and a variation in the work time of each division range (step S2905).

Next, the maintenance process flow design system 201 determines whether the processing has been executed for all combinations of the division ranges (step S2906).

When it is determined that the processing has not been executed for all combinations of the division ranges, the maintenance process flow design system 201 returns to step S2902 and executes the same processing.

When it is determined that the processing has been executed for all combinations of the division ranges, the maintenance process flow design system 201 proceeds to step S112.

In step S112, the maintenance process flow design system 201 sorts process flows of the combinations of the division ranges based on a total value of work cost and the variation in the work time, and generates a list of the process flows. Although the maintenance execution periods are different, there is no significant difference in the total value of the work cost since maintenance is executed for all the elements included in the maintenance range. Therefore, the process flows are sorted based on the variation in the work time.

According to the second embodiment, efficient process flows having different maintenance execution periods can be set.

### Third Embodiment

In a third embodiment, a specific method of utilizing the computer system described in the first and second embodiments will be described.

Each constraint, the master process flow information 234 and a work time calculation equation can be registered as data, a subroutine of program processing, a function, or a class in the case of object-oriented programming depending on a target system such as a plant, a facility and a building that generate a process flow, and can have a variable configuration. Therefore, a target maintenance schedule is planned by customizing each constraint according to various customer systems, the master process flow information 234, and the work time calculation equation.

FIG. 30 is a view showing an example of a business model utilizing the computer system described in the first or second embodiment.

The maintenance process flow design system 201 holds a system information group 3000 for each customer.

The system information group 3000 includes the configuration information 231, the remaining life information 232, the equipment information 233, the master process flow information 234, the work time calculation equation information 235 and constraint information 3012. The constraint information 3012 is information defining pipe constraints, reachability constraints and work space constraints in a customer system. These pieces of information are set using system integration (SI). Setting may be made by using a system introduction service, a consulting service or the like other than the SI.

The system information group 3000 includes a customization logic 3010 defining processing procedures for input and output and process flow design, and a constraint processing unit 3011. These are set by programming.

The maintenance process flow design system 201 generates a process flow and outputs the process flow to the scheduling system 202. The scheduling system 202 generates a schedule of the process flow and outputs the schedule to the O&M simulator 203. The O&M simulator 203 outputs KPI of the schedule.

Processing for generating the schedule is set as a service menu to be sold as a provided service. The processing may also be sold as a software system. System integration may also be a service menu.

The business model utilizing the maintenance process flow design system 201 according to the invention has been described as above.

The invention is not limited to the above embodiments, and includes various modifications. In addition, for example, the embodiments described above have been described in detail for easy understanding of the invention, and the invention is not necessarily limited to those including all the configurations described above. In addition, apart of the configuration of each embodiment can be added, deleted, or replaced with another configuration.

Each of the configurations, functions, processing units, processing methods or the like described above may be partially or entirely implemented by hardware such as through design using an integrated circuit. Further, the invention can also be implemented by program code of software that implements the functions of the embodiment. In this case, a storage medium storing the program code is provided to a computer, and a processor included in the computer reads out the program code stored in the storage medium. In this case, the program code itself read out from the storage medium implements the functions of the above-mentioned embodiment, and the program code itself and the storage medium storing the program codes constitute the invention. As a storage medium for supplying such a program code, for example, a flexible disk, a CD-ROM, a DVD-ROM, a hard disk, a solid state drive (SSD), an optical disk, a magneto-optical disk, a CD-R, a magnetic tape, a nonvolatile memory card, a ROM or the like is used.

Further, the program code for realizing the functions described in the present embodiment can be implemented in a wide range of programs or script languages such as assembler, C/C++, perl, Shell, PHP, Python and Java (registered trademark).

Further, the program code of the software that realizes the functions of the embodiments may be stored in a storage section such as a hard disk or a memory of a computer or a storage medium such as a CD-RW or a CD-R by delivering via a network, and a processor included in the computer may read out and execute the program code stored in the storage section or the storage medium.

In the embodiments described above, control lines and information lines are considered to be necessary for description, and all control lines and information lines are not necessarily shown in the product. All configurations may be connected to each other.

### REFERENCE SIGN LIST

201 maintenance process flow design system

202 scheduling system

203 O&M simulator

205 processor

206 memory

207 network interface

211 information acquisition unit

212 essential pipe selection unit

213 process planner

214 evaluation value calculation unit

215 process flow selection unit

221 maintenance range extraction unit

222 crane necessity determination unit

223 reachability determination unit

224 stage necessity determination unit

225 workload calculation unit

226 process flow generation unit

231 configuration information

232 remaining life information

233 equipment information

234 master process flow information

235 work time calculation equation information

241 system line semantic information

242 pipe connection information

243 flow path information

244 cyclic path information

251 accessibility (graph) information

252 accessibility (worker) information

253 height range information

254 pipe surrounding region information

261 pipe region information

262 workable region information

263 pipe size information

264 pipe density information

300 CAD

3000 system information group

3010 customization logic

3011 constraint processing unit

3012 constraint information

1. A maintenance process flow generation device configured to generate a maintenance process flow for a plant including a plurality of pipes and a plurality of machines as elements, the maintenance process flow generation device comprising:
a processor;
a storage device connected to the processor; and
an interface connected to the processor,
wherein the maintenance process flow generation device
holds configuration information on the plurality of elements included in a target plant, connection of the plurality of elements and coordinates of the plurality of elements, life information on life of each of the plurality of pipes, and master process flow information defining an order relationship of processes serving as maintenance work,
specifies a target pipe based on the life information,
extracts a maintenance range that is a combination of the elements as maintenance targets including the target pipe based on the configuration information,
determines necessity of a process required for maintenance on the plurality of elements capable of being collectively maintained based on the configuration information,
generates a process flow defining the order relationship of the processes executed in the maintenance of the target plant based on a result of the process necessity determination and the master process flow information,
evaluates workability of the process included in the process flow based on the configuration information,
calculates work time of the process flow based on a result of the workability evaluation, and
outputs information presenting the maintenance range, the process flow and the work time.

2. The maintenance process flow generation device according to claim 1,
wherein the maintenance process flow generation device
evaluates cost of the process flow for the maintenance range, and
selects an optimal process flow based on a result of the cost evaluation.

3. The maintenance process flow generation device according to claim 1,
wherein the master process flow information
is information defining an order relationship of processes related to the element, an order relationship of processes according to a height of an installation location of the element, and an order relationship of processes independent of the element and the installation location of the element, and
stores an entry configured by elements including a process name, a component name, height information, unique work time and height determination,
the order relationship of the processes related to the element defines an order of a process of dismantling and construction of the element, and a process of preparation and post-processing setup for the element,
the order relationship of the processes according to the height of the installation location of the element defines an order of a process of installation and removal of a crane, and a process of installation and dismantling of a stage defined according to the height determination, and
the order relationship of the processes independent of the element and the installation location of the element defines a process inserted before or after a specific process.

4. The maintenance process flow generation device according to claim 1,
wherein the maintenance process flow generation device
calculates the work time of the process flow using a mathematical equation with the result of the workability evaluation and process construction capability as parameters, and
the equation is defined as a sum of process unique time unique to the process, and target work time calculated by an equation with a number and sizes of the elements as process targets, a breadth and a height of a space where the process is executed, presence or absence of an obstacle therein, and a workload related to equipment of the target plant as parameters.

5. The maintenance process flow generation device according to claim 1,
wherein the maintenance process flow generation device
extracts the maintenance range using pipe constraints for extracting a system line by determining a connection state by selecting the element,
determines necessity of a process related to a stage and a crane for the plurality of elements that is capable of being collectively maintained by using reachability constraints for spatially determining that a worker and the crane can access and work on the element, and
determines a size and a weight of the element, and a breadth of a space where the process is executed and evaluates the workability of the process included in the process flow using work space constraints for quantifying the workability.

6. The maintenance process flow generation device according to claim 5,
wherein the pipe constraints includes:
a constraint on system line semantics set in the configuration information with an attribute value representing semantics of the connection of the plurality of elements as a constraint,
a constraint on connectivity of the pipes for acquiring a graph representing the connection of the pipes including the target pipe,
a constraint on a flow path for obtaining the flow path from the element designated as a start point to the element designated as an end point via a designated pipe, and
a constraint on a path along the pipe for acquiring the path that circulates from a start point to the start point via a designated pipe.

7. The maintenance process flow generation device according to claim 5,
wherein the reachability constraints includes:
a constraint on accessibility for listing the elements inside a cyclic path serving as an outer periphery of the maintenance range,
a constraint on worker accessibility for specifying the cyclic path of the elements that the worker is unable to reach and the installation location of the stage,
a constraint on an overlap of height ranges for determining whether a shared stage is required, and
a constraint, related to access of the crane, and on a region around the pipe for determining possibility of arranging the crane in a region outside the maintenance range or a work radius at which a hanging bracket is capable of accessing the pipe.

8. The maintenance process flow generation device according to claim 5,
wherein the work space constraints includes:
a constraint on a region including the pipe for evaluating an area of an offset region of the pipe included in the maintenance range and evaluating presence or absence of the pipe in the offset region,
a constraint on a workable region for evaluating a distance from the pipe to another pipe,
a constraint on a size of the pipe for determining an offset amount according to a weight due to a diameter, a length and a wall thickness of the pipe, and
a constraint on density of the pipes for evaluating the workability based on the number of pipes inside a region to

9. The maintenance process flow generation device according to claim 5,
wherein, when the necessity of the process related to the stage and the crane for the plurality of elements that is capable of being collectively maintained is determined based on the configuration information, the maintenance process flow generation device determines necessity of the crane based on the configuration information and the constraint on the size of the pipe, and determines necessity of the stage based on the configuration information and the constraint on the overlap of the height ranges.

10. The maintenance process flow generation device according to claim 1,
wherein the maintenance process flow generation device
generates a schedule by allocating workers, materials and equipment resources to the process included in the process flow,
evaluates cost and profit in the target plant, and
determines quality of the schedule based on a result of the cost and profit evaluation for the target plant.

11. A maintenance process flow generation method executed by a device configured to generate a maintenance process flow for a plant including a plurality of pipes and a plurality of machines as elements,
the device
including a processor, a storage device connected to the processor, and an interface connected to the processor, and
holding configuration information on the plurality of elements included in a target plant, connection of the plurality of elements and coordinates of the plurality of elements, life information on life of each of the plurality of pipes, and master process flow information defining an order relationship of processes serving as maintenance work,
the maintenance process flow generation method comprising:
a first step of specifying, by the device, a target pipe based on the life information;
a second step of extracting, by the device, a maintenance range that is a combination of the elements as maintenance targets including the target pipe based on the configuration information;
a third step of determining, by the device, necessity of a process required for maintenance on the plurality of elements that is capable of being collectively maintained based on the configuration information;
a fourth step of generating, by the device, a process flow defining the order relationship of the processes executed in the maintenance of the target plant based on a result of the process necessity determination and the master process flow information;
a fifth step of evaluating, by the device, workability of the process included in the process flow based on the configuration information;
a sixth step of calculating, by the device, work time of the process flow based on a result of the workability evaluation; and
a seventh step of outputting, by the device, information presenting the maintenance range, the process flow and the work time.

12. The maintenance process flow generation method according to claim 11, further comprising:
a step of evaluating, by the device, cost of the process flow for the maintenance range; and
a step of selecting, by the device, an optimal process flow based on a result of the cost evaluation.

13. The maintenance process flow generation method according to claim 11,
wherein the master process flow information
is information defining an order relationship of processes related to the element, an order relationship of processes according to a height of an installation location of the element, and an order relationship of processes independent of the element and the installation location of the element, and
stores an entry configured by elements including a process name, a component name, height information, unique work time and height determination,
the order relationship of the processes related to the element defines an order of a process of dismantling and construction of the element, and a process of preparation and post-processing setup for the element,
the order relationship of the processes according to the height of the installation location of the element defines an order of a process of installation and removal of a crane, and a process of installation and dismantling of a stage defined according to the height determination, and
the order relationship of the processes independent of the element and the installation location of the element defines a process inserted before or after a specific process.

14. The maintenance process flow generation method according to claim 11,
wherein the sixth step includes a step of calculating, by the device, the work time of the process flow using a mathematical equation with the result of the workability evaluation and process construction capability as parameters, and
the equation is defined as a sum of process unique time unique to the process, and target work time calculated by an equation with a number and sizes of the elements as process targets, a breadth and a height of a space where the process is executed, presence or absence of an obstacle therein, and a workload related to equipment of the target plant as parameters.

15. The maintenance process flow generation method according to claim 11,
wherein the second step includes a step of extracting, by the device, the maintenance range using pipe constraints for extracting a system line by determining a connection state by selecting the element,
the third step includes a step of determining, by the device, necessity of a process related to a stage and a crane for the plurality of elements that is capable of being collectively maintained by using reachability constraints for spatially determining that a worker and the crane are capable of accessing and work on the element, and
the fifth step includes a step of determining, by the device, a size and a weight of the element, and a breadth of a space where the process is executed and evaluating, by the device, the workability of the process included in the process flow using work space constraints for quantifying the workability.

16. The maintenance process flow generation method according to claim 15,
wherein the pipe constraints includes:
a constraint on system line semantics set in the configuration information with an attribute value representing semantics of the connection of the plurality of elements as a constraint,
a constraint on connectivity of the pipes for acquiring a graph representing the connection of the pipes including the target pipe,
a constraint on a flow path for obtaining the flow path from the element designated as a start point to the element designated as an end point via a designated pipe, and
a constraint on a path along the pipe for acquiring the path that circulates from a start point to the start point via a designated pipe.

17. The maintenance process flow generation method according to claim 15,
wherein the reachability constraints includes:
a constraint on accessibility for listing the elements inside a cyclic path serving as an outer periphery of the maintenance range,
a constraint on worker accessibility for specifying the cyclic path of the elements that the worker is unable to reach and the installation location of the stage,
a constraint on an overlap of height ranges for determining whether a shared stage is required, and
a constraint, related to access of the crane, and on a region around the pipe for determining possibility of arranging the crane in a region outside the maintenance range or a work radius at which a hanging bracket is capable of accessing the pipe.

18. The maintenance process flow generation method according to claim 15,
wherein the work space constraints includes:
a constraint on a region including the pipe for evaluating an area of an offset region of the pipe included in the maintenance range and evaluating presence or absence of the pipe in the offset region,
a constraint on a workable region for evaluating a distance from the pipe to another pipe,
a constraint on a size of the pipe for determining an offset amount according to a weight due to a diameter, a length and a wall thickness of the pipe, and
a constraint on density of the pipes for evaluating the workability based on the number of pipes inside a region to be worked on at a time.

19. The maintenance process flow generation method according to claim 15,
wherein the third step includes:
a step of determining, by the device, necessity of the crane based on the configuration information and the constraint on the size of the pipe; and
a step of determining, by the device, necessity of the stage based on the configuration information and the constraint on the overlap of the height ranges.

20. The maintenance process flow generation method according to claim 11, further comprising:
a step of generating, by the device, a schedule by allocating workers, materials and equipment resources to the process included in the process flow;
a step of evaluating, by the device, cost and profit in the target plant; and
a step of determining, by the device, quality of the schedule based on a result of the cost and profit evaluation for the target plant.
